(19) United States
(12) Patent Application Publication
(10) Pub. No.: US 2009/0303489 A1
(43) Pub. Date: Dec. 10, 2009

(54) Surface Plasmons

(75) Inventors: Thomas David Paul Allsop, South Humberside (GB); David John Webb, Shropshire (GB); Ronald Neal, Cornwall (GB); Ian Bennion, Northamptonshire (GB)

Correspondence Address: SWANSON & BRATSCHUN, L.L.C., 8210 SOUTHPARK TERRACE, LITTLETON, CO, 80120, US

(73) Assignee: ASTON UNIVERSITY, West Midlands (GB)

(21) Appl. No.: 12/306,225

(22) PCT Filed: Jul. 13, 2007
(86) PCT No.: PCT/GB07/02643

§ 371 Date: Jun. 3, 2009

(30) Foreign Application Priority Data
Jul. 13, 2006 (GB) 0613959.6

(51) Int. Cl. G01N 21/55

(52) U.S. Cl. 356/445; 250/493.1

(57) ABSTRACT

The generation of surface plasmons on a metal layer arranged upon an outer surface of an optical waveguide, using light reflected from inside the optical waveguide. The reflected light may be a reflected part of guided light travelling along the optical waveguide and may be a back-reflected (e.g. obliquely back-reflected) part of the guided light. The reflected part of guided light may form a radiative optical mode(s) which is used to excite surface plasmons and which is also coupled to the remaining guided mode(s) of the light from which it derives. This coupling of the radiation mode(s) and the guided mode(s) enables changes in the radiation mode(s) to cause consequential changes in the guided mode(s) of light. Such changes in the radiation mode(s) may occur due to the coupling of the reflected mode(s) to the surface plasmons they excite at the metal layer.

The present invention relates to the generation of surface Plasmons, and particularly, though not exclusively, to sensing methods and apparatus using surface Plasmons.

Free electrons of a metal can be treated as an electron liquid of high density. At the surface of a metal, longitudinal electron density fluctuations, or plasma oscillations, may occur and will propagate along the surface.

These coherent fluctuations are accompanied by an electromagnetic field comprising a component transverse to the surface, and a component(s) parallel to the surface. The transverse electromagnetic field falls rapidly with increasing distance from the metal surface, having its maximum at the surface, and is sensitive to the properties of the metal surface and the properties of the dielectric substance (e.g. air, aqueous solution) immediately at and above the surface and into which the transverse electric field component extends.

This propagating free electron surface charge fluctuation, and its attendant electromagnetic field, is a surface plasmon.

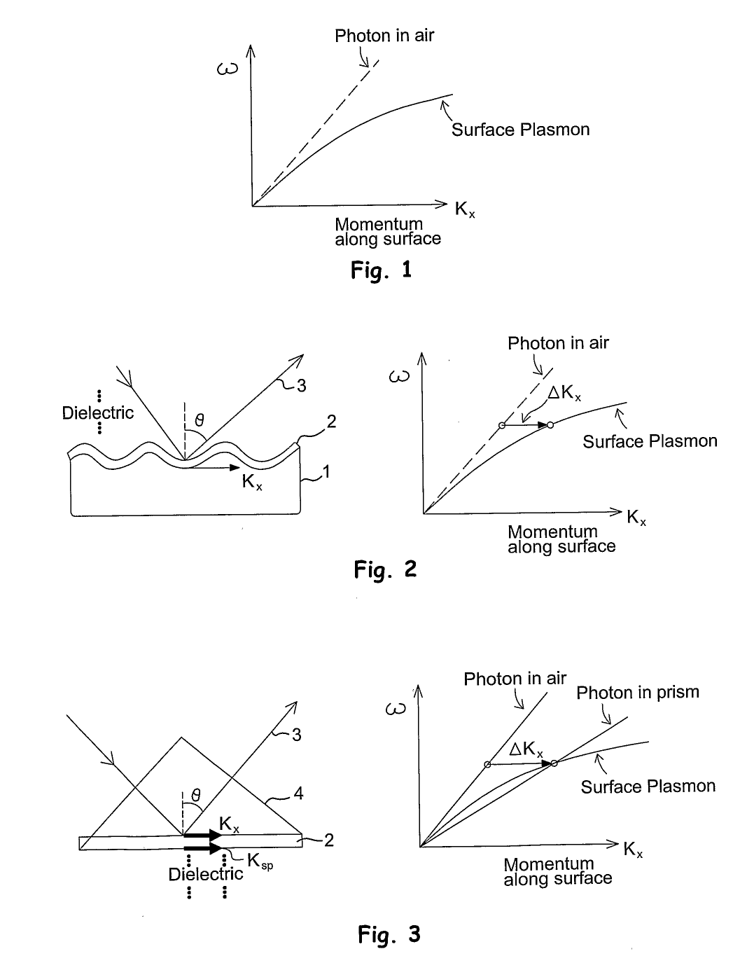

A surface plasmon can propagate along a metallic surface with a broad spectrum of eigen frequencies from ω=0 up to a maximum value depending upon its wave vector k. The dispersion relation ω(k) of a surface plasmon, which relates the eigen frequency to the wave vector, shows that surface plasmons have a longer wave vector than light of the same energy propagating along the surface. Surface plasmons are, as a consequence, non-radiative and are characterised as surface waves having an electromagnetic field which decays exponentially with increasing distance from, and transverse to, the surface upon which they propagate. Due to the differing dispersion relations of photons (in air) and surface plasmons, and the non-radiative nature of surface plasmons, photons in air cannot couple to surface plasmons. This is schematically illustrated in FIG. 1 which shows the dispersion relation of photons (in air) and surface plasmons graphically. The dispersion curve of the photon (in air) never crosses the dispersion curve of the surface plasmon. Consequently, the two cannot couple or “transform” between each other due to being unable to satisfy the requirements of both energy and momentum conservation during “transformation”.

Excitation of surface plasmons is not possible using photons (in air) unless a means is used to transfer additional momentum (Δkₓ) to the photon such that, for a given photon frequency, the photon momentum is equal to the momentum permitted for a surface plasmon at the same frequency.

One means of achieving this is to form the metal surface 2 upon a diffraction grating surface 1 (e.g. by forming corrugations in the surface). When light 3 strikes the metal grating surface, having a grating constant a, at an angle e, the component (kₓ) of the wave vector of the light along the surface becomes:

$${k}_{x} = \frac{ω}{c} sin ( θ ) \pm \frac{2 π n}{a}$$

Where n is an integer and c is the speed of light in a vacuum. Thus, the metal surface grating may impart the extra momentum (Δkₓ=2πn/a) needed by the photon to enable it to reach the surface plasmon dispersion curve to “transform” into (i.e. excite) a surface plasmon. FIG. 2 graphically illustrates this.

The reflected light intensity attenuates when excitation of surface plasmons is greatest and photons “transform” into surface plasmons resonantly.

Another means for photon-plasmon coupling is the use of “attenuated total reflection” (ATR) such as exemplified by the so-called Kretschmann-Raether prism arrangement schematically illustrated in FIG. 3. Light 3 is directed towards an interface with a metal surface 2 using a prism 4 made of a material having a refractive index nₚ (e.g. quartz), at which it is totally reflected. The dispersion relation of photons in the prism, and reaching the interface, is ω=ck/nₚ. Thus, the extra momentum (Δkₓ) required by the photon to couple to surface plasmons arises from the optical properties of the coupling prism 5. Photons may excite plasmons when the component (kₓ) of the wave vector of the reflected light (in-prism) matches that permitted by surface plasmons of the same frequency, i.e.:

$${k}_{x} = {n}_{p} \frac{ω}{c} sin ( θ ) = {k}_{sp}$$

Where θ is the angle of incidence at which light is totally reflected. FIG. 3 graphically illustrates this. This resonant “transformation” of photons into surface plasmons results in an attenuation of the totally reflected light exiting the prism, hence the appellation “attenuated total reflection”.

Thus, both means of resonantly coupling photons to surface plasmons (grating surfaces, (ATR etc) result in “surface plasmon resonances” (SPR) indicated by a resonant drop in reflected light from the plasmon-bearing metal interface. Since the surface plasmon propagates at the outwardly presented surface of the metal in question, the optical properties of the dielectric material (e.g. air, aqueous solution etc) to which the metal surface is outwardly presented (e.g. exposed), become highly influential upon the nature and degree of the resonant attenuation of reflected light used to resonantly excite the surface plasmons. This fact is exploited in sensor devices which measure properties of dielectric sample substances using surface plasmons generated as discussed above.

If the relative dielectric constants of the metal surface and the dielectric material at the outwardly presented (e.g. exposed) surface of the metal, are εₘ and ε_{d} respectively, then the wave vector kₛₚ of a surface plasmon propagating at the outwardly presented (e.g. exposed) metal surface, and extending transversely thereto into the dielectric material is:

$${k}_{sp} = \frac{ω}{c} {( \frac{{ɛ}_{m} {ɛ}_{d}}{{ɛ}_{m} + {ɛ}_{d}} )}^{1 / 2}$$

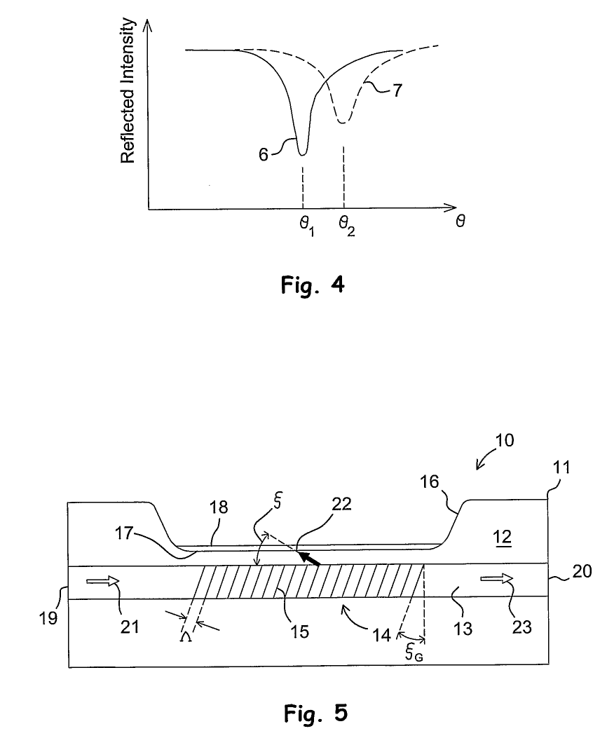

Thus, the value of ε_{d} determines the value of kₛₚ and thus the angle of incidence (θ) upon the plasmon-bearing surface at which a photon can resonantly excite surface plasmons. Thus, by monitoring the intensity of reflected light to determine the position of resonant attenuation of reflected light, one may determine a measure of ε_{d}. Changes in ε_{d} may also be monitored as changes in the angular position of the reflected light attenuation resonance. FIG. 4 schematically illustrates an example of two attenuation resonances occurring at different reflection angles (θ₁ and θ₂) each corresponding with the presence of a dielectric material of a different respective ε_{d} at the outwardly presented (e,g, exposed) metal plasmon-bearing surface.

The value of ε_{d} is intimately related to the properties (e.g. optical properties) of the dielectric substance which can, in this way, be sensed and probed using surface plasmons. For example, the value of the refractive index (n_{d}) of the dielectric is equal to the square root if its dielectric constant (n_{d}²=ε_{d}). However, these prior art surface plasmon generating arrangements, and sample sensing methodologies, either require plasmon-exciting light to first pass through the dielectric sample (ε_{d}) being sensed (e.g. surface grating arrangements), or require bulky and cumbersome prisms (the Kretschmann arrangement) which also suffer from in-prism reflected light losses due to reflection at prism surfaces. Both of the above techniques fundamentally rely upon monitoring changes in the intensity of reflected plasmon-exciting light and so suffer the detrimental consequences of irregularities or impurities at the light-reflecting (prism or grating) surface.

The present invention aims to address at least some of the above deficiencies.

As its most general, the present invention proposes the generation of surface plasmons on a metal layer arranged upon an outer surface of an optical waveguide, using light reflected from inside the optical waveguide. The reflected light is most preferably a reflected part of guided light travelling along the optical waveguide and is preferably a back-reflected (e.g. obliquely back-reflected) part of the guided light, e.g. having a wave vector, or a component thereof, directed oppositely to that of the un-reflected guided light).

In this way, the present invention may enable the reflected part of guided light to form a radiative optical mode(s) which is used to excite surface plasmons and which is also coupled to the remaining guided mode(s) of the light from which it derives.

This coupling of the radiation mode(s) and the guided mode(s) enables changes in the radiation mode(s) to cause consequential changes in the guided mode(s) of light. Such changes in the radiation mode(s) may occur due to the coupling of the reflected mode(s) to the surface plasmons they excite at the metal layer. Thus, the greater the degree of coupling between the radiative optical mode(s) and the surface plasmons in question, the greater the consequential change in the remaining guided mode(s) to which the radiative mode(s) are coupled. In this way, the extent of surface plasmon generation is imprinted upon, or leaves a signature within, the properties of the remaining guided mode(s) of the light used to excite the surface plasmons.

The present invention proposes, in one of its aspects, the sensing of substances at an outwardly presented (e.g. exposed) surface of the metal layer by monitoring the properties (e.g. intensity) of the remaining transmitted guided mode(s) of light within the optical waveguide, a part of which light has been removed by the aforesaid reflection, for the presence of surface plasmons generated at the metal layer by the reflected light. This methodology is to be contrasted with existing methodologies of surface plasmon generation and sensing, which monitor properties of plasmon-exciting light reflected from a metal surface (e.g. the ATR method).

Advantages of using an optical waveguide in this way for these purposes include removal of the need to fabricate and metallically coat surface gratings, which are delicate, costly to manufacture, and prone to collecting irregularities or impurities and, in use as a sample sensor, require transmission of plasmon-exciting light through the sample being sensed. Also, bulky and optically lossy coupling prisms are not required. The small size, internal robustness, and general versatility of optical waveguides (e.g. optical fibres) render the present invention suitable for providing small and robust surface plasmon generators and sensors. Since it is the guided optical mode (within the optical waveguide proposed by the invention) which may be monitored for the purposes of sample sensing using surface plasmons, the optical waveguide of the present invention enables relatively long-distance transmittal of the guided light and, therefore, easy use of remotely situated monitoring apparatus. One is not required to monitor plasmon-generating reflected light in order to sense samples under study and need not position monitoring equipment in close proximity to the sample as would otherwise be required in order to collect the reflected light in question.

In a first of its aspects, the present invention may provide a surface Plasmon generator including an optical waveguide (e.g. an optical fibre) having an input part for receiving optical radiation (e.g. controlled radiation or signals) into the optical waveguide, a refractive index modulation arranged within the optical waveguide, and a layer of metal arranged upon a surface of the optical waveguide to form an interface therewith and to outwardly present a metal surface covering the interface, wherein the refractive index modulation extends (e.g. an area or region of common or uniform refractive index) to form an area obliquely facing the interface thereby to render the interface in optical communication with the input part by reflection of part of an input optical radiation/signal at the refractive index modulation for generating a surface Plasmon at the metal surface. Preferably, the area formed by the refractive index modulation faces obliquely the direction from which it is arranged to receive optical radiation from the input part. For example, when the input part and the refractive index modulation are arranged in-line along a linear optical waveguide, the area defined by the refractive index modulation obliquely faces the input part. The area defined by the refractive index modulation preferably obliquely intercepts the optical transmission axis of the optical waveguide. The optical waveguide may be any suitable optical waveguide structure such as would be readily apparent to the skilled person, and is preferably an optical fibre. The metal surface is most preferably exposed e.g. such that substances may directly contact the metal surface. This enables the component of the electromagnetic field of the surface plasmon transverse to the metal surface to extend directly into (and be influenced by) the substance.

In this way, the invention permits the use of a reflected part of guided modes of optical radiation in an optical waveguide, for exciting surface plasmons at a metal layer at a surface thereof. The reflective area formed by the refractive index modulation may be an axially transversely extending boundary or region defining the beginning of the modulation (e.g. in an axial direction in the waveguide) and/or may be a region of common (modulated) refractive index within the optical waveguide which may define a substantially discontinuous, or step-wise, increase in refractive index or may define a continuous increase in refractive index. As is well-known in the art, and to those familiar with Fresnel's equations, the presentation of a refractive index modulation to optical radiation guided by the optical waveguide will case a component thereof to be reflected upon reaching the refractive index modulation, and a component to be transmitted through the refractive index modulation.

The nature of the refractive index modulation e.g. the degree of index change, rate of index change spacially) determines how much incident optical radiation is reflected thereby, and how much is transmitted. When refractive index modulations define a diffraction grating, the degree of refractive index change determines what is commonly referred to as the “strength” of the grating.

The refractive index modulation may be formed using known optical waveguide inscription techniques, such as by exposing an optical waveguide to focussed ultraviolet radiation therewith to alter the optical properties (refractive index) of waveguide material positioned at the focus of the ultraviolet radiation.

The refractive index modulation may extend across at least a part of the optical waveguide. The aforesaid extended area formed by the refractive index modulation may form a continuous boundary area or interface area, internal to the optical waveguide, between those parts of the optical waveguide which are not index modulated and those which are, which extends in the direction transverse to the axis of the waveguides so as to be presented to optical signals guided along the waveguide and to reflect at least a part of those optical signals obliquely backwards. The refractive index modulation may be formed adjacent the metal layer, which may overlay the refractive index modulation. The refractive index modulation may extend across the axis of the waveguide to face the interface with the metal layer highly obliquely. For example, the area formed by the refractive index modulation may be inclined from the perpendicular to the interface by between 0.5° and 15°, preferably between 1° and 13°, and more preferably between 1° and 9°, inclusive, yet more preferably between 3° and 9°, and preferably about 7°, 8° or 9°. In this way, reflected optical signals may be imparted, by reflection, with a wave vector having a component which is directed transversely to the axis of the optical waveguide directly towards the interface, even though the wave vector itself may not, as a whole, be directed towards the interface. This enables radiative modes to be generated at the optical waveguide which impinge upon the interface.

The refractive index modulation may define a substantially planar area obliquely presented to the interface and preferably obliquely presented to the direction from which it is arranged to receive optical radiation from the input part. This planar area may be tilted towards the interface such that a line perpendicular to the interface is inclined to the plane area by an angle between 0.5° and 15°, preferably between 1° and 13°, and more preferably between 1° and 9°. More preferably, the tilt angle is between 3° and 9°, inclusive, and preferably is about 7°, 8° or 9°. Preferably, the normal to the interface and the normal to the area defined by the refractive index modulation, are coplanar, and preferably so too is the optical transmission axis of the waveguide at the refractive index modulation.

The optical waveguide may be maintained in an un-flexed state, at least in the proximity of the metal layer thereby reducing the space required by the surface Plasmon generator, reducing stresses on the metal layer. The optical waveguide may possess optical waveguide cladding but is preferably otherwise not itself embedded, or encased in any holding substrate of material (such as epoxy), thus, the outer circumferential surface/length of the optical waveguide may be exposed.

The optical waveguide may have an optical waveguide core part and an optical waveguide cladding part adjacent the core part, and the refractive index modulation may extend across at least a part of the core part of the optical waveguide. The index modulation may preferably be confined to the core part and may extend across the core part fully. The coupling of radiative modes to surface plasmons may be enhanced by enhancing the relative strength of the radiative modes.

The surface Plasmon generator may include a plurality of said refractive index modulations collectively defining a tilted diffraction grating structure within the optical waveguide extending along the optical transmission axis thereof. Such a structure enhances radiative mode coupling and not only to surface plasmons at the metal layer, but also to guided modes within the optical waveguide. This is found to be particularly so when the grating is structured such that interference between the counter-propagating optical modes, of input optical radiation and the deflected parts thereof, is enhanced. Waveguide (e.g. fibre) Bragg gratings are adapted to achieve this, and most preferably the diffraction grating is a tilted waveguide (e.g. fibre) Bragg grating. The diffraction grating may preferably have a strength of between a few dBs (e.g. about 4 dBs) and about 25 dBs or more. The Bragg grating period may be about 0.5 μm, but other optimal values may be used.

The optical waveguide may have a core part and a cladding part adjacent to the core part which is lapped to define a proximal outer surface area being closer to the core part than are other adjacent outer surface areas of the cladding part. The layer of metal may be formed upon the proximal outer surface area, which may, but preferably does not, expose a part of the waveguide core. The lapped cladding part enables not only the formation of a flat interface and outwardly presented (e.g. exposed) outer metal surface, but also enables greater proximity of the interface to the core part of the optical waveguide from which surface plasmon inducing radiative modes derive. The lapped region of the waveguide may be such as to present a D-shaped cross-sectional profile if viewed in a direction along the waveguide (e.g. fibre) axis, the proximal outer surface area defining the flat part of the D. The thickness of cladding at the lapped cladding part is preferably between about 15 μm and 5 μm, though other optimal thicknesses may be employed.

The selected outer surface area may be substantially flat, and may be generally parallel to the axis of the waveguide core part, at least at the location of the refractive index modulation(s), and may be arranged to substantially extend over, or overlap, the refractive index modulation(s) when the outer surface area is viewed face-on.

The metal may be Silver (Ag) or Gold (Au). The layer of metal may be directly bonded or coated upon the selected outer surface area, or may be indirectly bonded thereto via an intermediate bonding agent, the layer of metal may otherwise be placed in contact with the selected outer surface or may be spaced therefrom without being bonded thereto. The metal layer may be between 10 nm and 50 nm in thickness, and may preferably be between 30 nm and 40 nm in thickness, preferably being about 35 nm in thickness.

The metal layer may be formed to have a thickness which varies with a standard deviation which has a value equal to or less than about 20% of the average value of the thickness, or between 20% and 10% of the average value of the thickness, or between 20% and 15% of the average value of the thickness. Variations in the value of the thickness of the metal layer relative to the average thickness of the layer, may be in the range 6 nm to 60 nm, or 15 nm to 35 nm, or 20 nm to 30 nm. These thickness variations may preferably occur over surface regions extending between 0.2 mm and 3 mm. The metal surface may preferably possess a grainy surface with grains predominantly being between 0.5 mm and 3 mm in length, and/or 0.1 mm and 2 mm in width, and/or between 15 nm and 35 nm in height.

Such grain dimensions have been found to support the generation of surface Plasmons which possess a propagation length of between 0.04 microns and 0.15 microns, which are therefore highly localised. The propagation length of surface plasmons generated according the invention is short as compared to their spatial extension (probe depth) transverse to the surface of the metal supporting the plasmons. This spatial extension may be in excess of 1.0 μm, and may be between about 1.0 μm and 2.0 μm (e.g. around 1.5 μm). The wavelength of the optical signal may be between 1100 nm and 1700 nm in these circumstances.

The aforesaid area formed by each said refractive index modulation may be substantially a plane area relative to which the diameter of the optical waveguide is inclined at an angle preferably in the range of angles from 0.5° to 15°, yet more preferably between 3° and 9°, inclusive, and preferably about 7°, 8° or 9°. The optical waveguide may be a clad single mode optical waveguide constructed and arranged to support single mode transmission of optical signals in the infra-red (IR), such as those having wavelengths above (e.g. only above) 1000 nm. Preferably, the grating vector (e.g. the normal to the grating planes), the longitudinal axis of the waveguide (e.g. fibre) at the grating, and the normal to the lapped surface all lie in a common plane.

The input part of the optical waveguide may be an end of the optical waveguide. The input part may, additionally or alternatively, include an optical coupler coupled to a part of the optical waveguide length.

The optical waveguide may include an output part comprising an end of the waveguide for receiving optical signals having passed through the refractive index modulation(s) from the input part. Output optical signals may thus be retrieved or detected directly at the output end of the optical waveguide. Alternatively, or additionally, an optical coupler may be coupled to a length of the optical waveguide for out-coupling output signals therefrom.

In a second of its aspects, the present invention may provide a sensor including a surface Plasmon generator according to the invention in its first aspect, an optical signal source in optical communication with the input part of the surface Plasmon generator, and an optical signal detector arranged to detect optical signals having passed through the refractive index modulation(s) from the input part, wherein the (e.g. exposed) metal surface defines a sensing area for receiving a sample to be sensed using surface Plasmons. In this way, guided optical modes output from the output part of the optical waveguide may be detected and monitored in order to detect, measure or monitor properties of a sample placed at the outer surface of the metal layer upon which surface plasmons are excited by radiative modes coupled to the detected guided modes via the refractive index modulation(s), e.g. titled Bragg grating.

The optical signal detector may be an optical spectrum analyser responsive to optical radiation generated by the optical signal source. The optical signal source may be operable to generate Infra-Red (IR) optical signals (e.g. only IR signals) and may be arranged to generate broadband optical signals comprising a range of optical wavelengths, e.g. all within the IR spectrum, such as only within the range 1000 nm to 2000 nm, or such as only the range 1100 nm to 1700 nm. Alternatively, the optical signal source may be arranged or operable to produce radiation having a wavelength within in the range 500 nm to 1000 nm, the optical signal detector being responsive thereto.

The sensor may include a polarisation control means in optical communication with the optical signal source and the input part of the surface Plasmon generator, arranged for controlling the state of polarisation of optical signals from the optical signal source for input to the surface Plasmon generator. It has been found that the degree of surface plasmon generation and/or the sensitivity of the sensor of the invention is dependent upon the state of polarisation of the guided optical signal modes input to the optical waveguide. The polarisation control means, being of a type and structure such as would be readily apparent to the skilled person, may be employed to tune the sensor's sensitivity accordingly.

In a third of its aspects, the present invention may provide a sample analyser for analysing a sample of a substance using surface Plasmon resonances including a sensor according to the invention in its second aspect. As has been discussed above, the degree of surface plasmon excitation, and the wavelength of optical signal used to resonantly excite surface plasmons, is detectable in the spectrum of the guided modes of the optical signal output by surface plasmon generator, as an output signal intensity attenuation resonance.

The sample analyser may include a signal processor means arranged to identify resonances in the spectrum of an optical signal received thereby from the optical signal source via the surface Plasmon generator. The signal processor means may be arranged to determine one or more of: the position; the depth or strength; the width of an identified said resonance within the spectrum of detected optical signals. These and/or other properties of the spectrum may be monitored or measured in analysing the sample substance in question. The signal processor means may include a computer means suitably programmed to effect such monitoring and/or measurement. Changes over a period of time, in any of the aforesaid properties, may be so monitored and/or measured and correlated to dynamic (or otherwise) properties of the sample in question.

The signal processor means may be arranged to determine the refractive index of a sample substance according to the spectral position (e.g. signal wavelength) and/or strength, depth or amplitude of identified output signal intensity attenuation resonance, and may be arranged to determine a change in said refractive index according to a change in said spectral position. The signal processor may be arranged to determine changes in the refractive index of a sample which are equal to or greater than about 2×10⁻⁵ or 3×10⁻⁵ in response to a change in said spectral position of 0.1 nm. This sensitivity is preferably provided in respect of samples having an index of refraction in the range 1.335 to 1.370 or above.

The sample analyser may include a sample control means for placing the sample in contact with the (e.g. exposed) outwardly presented metal surface of the surface Plasmon generator. This may comprise a sample bath (e.g. for solutions), container or receptacle within which the metal surface is presented.

It is to be understood that the apparatus and arrangements described above in any one or more the aspects of the invention, realises a corresponding method of surface plasmon generation, of sensing using surface plasmons, and of sample analysis using surface plasmons. These corresponding methods are encompassed by the invention.

In a fourth of its aspects, the present invention may provide a method for generating a surface Plasmon including: providing a surface Plasmon generator according to the invention in its first aspect; directing an optical signal into the surface Plasmon generator via the input part thereof; reflecting a part of the input optical signal at the refractive index modulation(s) towards the interface; generating a surface Plasmon at the metal surface using the reflected part of the input optical signal.

The spatial extension (probe depth) of the surface Plasmon transverse to the surface of the metal supporting the Plasmon may be in excess of 1.0 μm, and may be between about 1.0 μm and 2.0 μm (e.g. around 1.5 μm). The propagation length of the surface Plasmon may be between 0.04 microns and 0.15 microns. The wavelength of the optical signal may be between 1100 nm and 1700 nm in these circumstances.

Utilising a tilted/oblique refractive index variation (e.g. a tilted fibre Bragg grating) in the surface Plasmon generator enhances the coupling of the illuminating light to spatially localised surface Plasmons on a metal (e.g. silver) coated waveguide surface (e.g. a lapped optical fibre). It is found that by altering the polarisation of the light the surface Plasmon resonance in the transmission spectrum of the device could be tuned over a broad spectral range (e.g. from 1100 nm to 1700 nm) with extinction ratios in excess of 35 dB for the aqueous index regime (1.34 to 1.37). A polarisation dependence is found to occur which can be used to control the spatial extension of the SPR from the metal/dielectric interface at a given location.

The method may include directing a polarised optical signal into the surface Plasmon generator via the input part thereof, and varying the state of polarisation (e.g. polarisation angle, or azimuth, or ellipticity etc.) of the input optical radiation to vary the spatial extension of the surface Plasmon at a given location to extend varying distances outwardly from the outwardly presented metal surface.

The method may include directing a polarised optical signal into the surface Plasmon generator via the input part thereof, and varying the state of polarisation (e.g. polarisation angle, or azimuth, or ellipticity etc.) of the input optical radiation to vary the spectral width and/or spectral position of a surface Plasmon resonance (SPR) in the transmission spectrum of the surface Plasmon generator. The spectral width may be defined in terms of the width of the resonance at one half of its full depth (3 dB). The spectral position of an SPR may be defined in terms of the optical signal wavelength associated with the minimum, or effective minimum, of the SPR. The polarisation may be varied to produce an SPR width having a value from the range 200 nm to 500 nm, or 350 nm to 450 nm, or 350 nm to 400 nm. These values may be associated with the use of the device to measure of sense substances having a refractive index of between 1.3 and 1.4, or 1.33 and 1.36 (e.g. the aqueous regime).

In a fifth of its aspects, the present invention may provide a method of sensing including generating a surface Plasmon according to the invention in its fourth aspect with a sample substance placed in contact with the (e.g. exposed) outwardly presented metal surface of the Plasmon generator, transmitting a part of the input optical signal through the refractive index modulation(s) and detecting the intensity of the transmitted part of the input optical signal thereby to sense the sample substance using the surface Plasmon. The method may include sensing varying distances or depths from a given location on the outwardly presented metal surface by varying the polarisation state (e.g. angle) of the input optical signal to vary the spatial extension of the surface Plasmon from the metal layer into the sensed substance.

The method of sensing may include detecting a minimum in the signal intensity in the optical spectrum of the transmitted part of the input optical signal.

In a sixth of its aspects, the present invention may provide a method of sample analysis employing the method of sensing according to the invention in its fifth aspect and including measuring changes in a property of the transmitted part of the input optical signal in dependence upon changes in a property of the sample being sensed.

There now follow examples of the invention, with reference to the accompanying drawings, as non-limiting embodiments useful for understanding the invention at its most general.

FIG. 1 schematically illustrates the dispersion relation of a photon in air, and of a surface Plasmon;

FIG. 2 schematically illustrates a surface grating coupler for generating surface plasmons, together with a graphical dispersion relation illustrating the resonant excitation of a surface Plasmon using a photon in air coupled to the surface Plasmon via the grating;

FIG. 3 schematically illustrates a Kretschmann-Raether prism coupler for generating surface plasmons, together with a graphical dispersion relation illustrating the resonant excitation of a surface Plasmon using photons in the prism coupled to the surface Plasmon;

FIG. 4 schematically illustrates optical signal attenuation resonances in the spectrum of light reflected from a coupler of FIG. 2 or FIG. 3 in exciting surface plasmons;

FIG. 5 schematically illustrates a cross-sectional view of a surface Plasmon generator according to an example of the invention;

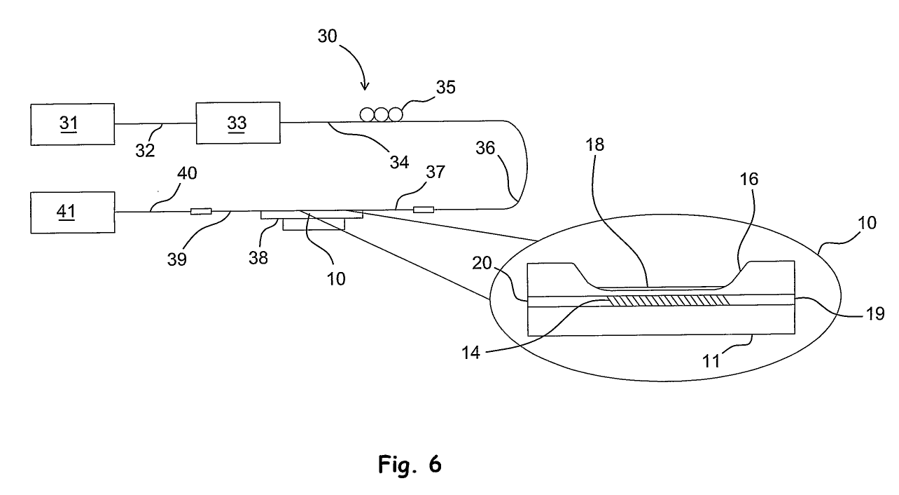

FIG. 6 schematically illustrates a sensor employing a surface Plasmon generator according to an example of the invention;

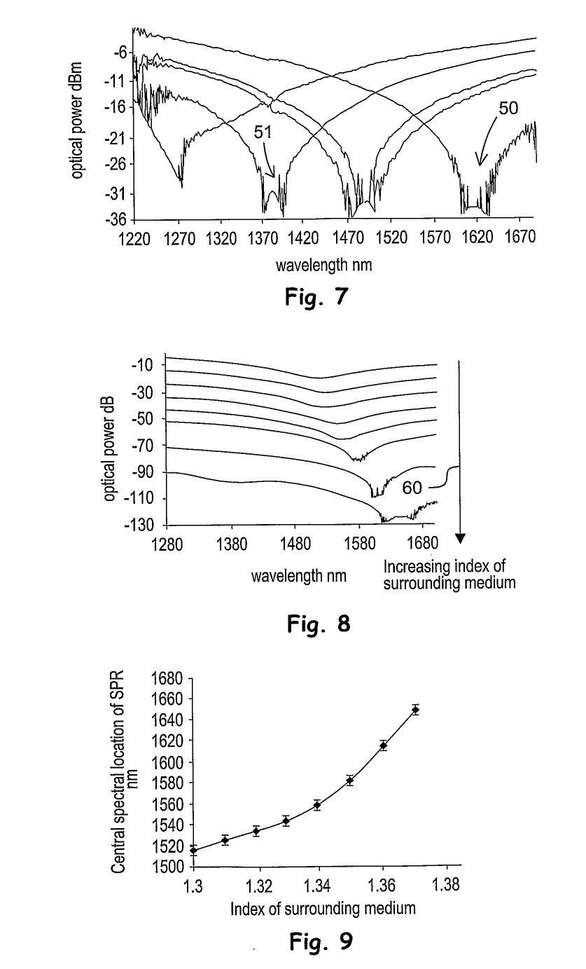

FIG. 7 graphically illustrates attenuation resonances in the spectrum of a transmitted optical signal by the surface Plasmon generator of FIG. 5, and resulting from the input thereto of optical signals having different polarisation sates;

FIG. 8 graphically illustrates attenuation resonances in the spectrum of a transmitted optical signal by the surface Plasmon generator of FIG. 5, and resulting from the presence at the exposed metal surface of the surface Plasmon generator of sample solutions each having a different one of a range of refractive indices, the input optical signal having a fixed state of polarisation;

FIG. 9 graphically illustrates the dependence of the position of an attenuation resonance of FIG. 8 upon the value of the refractive index of the sample solution being sensed;

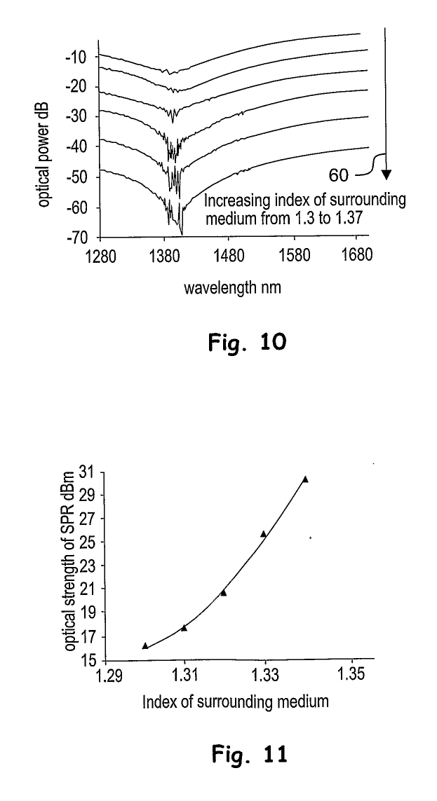

FIG. 10 graphically illustrates attenuation resonances in the spectrum of a transmitted optical signal by the surface Plasmon generator of FIG. 5, and resulting from the presence at the exposed metal surface of the surface Plasmon generator of sample solutions each having a different one of a range of refractive indices, the input optical signal having a fixed state of polarisation differing from that employed to produce the results shown in FIG. 8;

FIG. 11 graphically illustrates the dependence of the optical strength (depth) of attenuation resonances shown in FIG. 10, upon the refractive index of the sample solution being sensed;

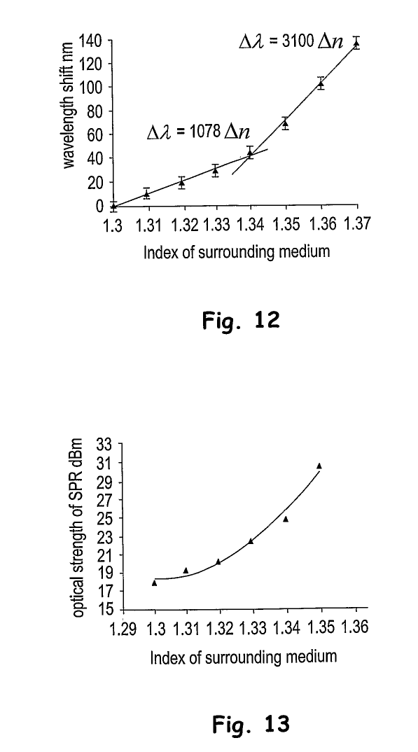

FIG. 12 graphically illustrates the dependence of changes in the spectral position of attenuation resonances of FIG. 8, upon the refractive index of the sample solution being sensed;

FIG. 13 graphically illustrates the dependence of the strength of the attenuation resonances of FIG. 8, upon the refractive index of the sample solution being sensed;

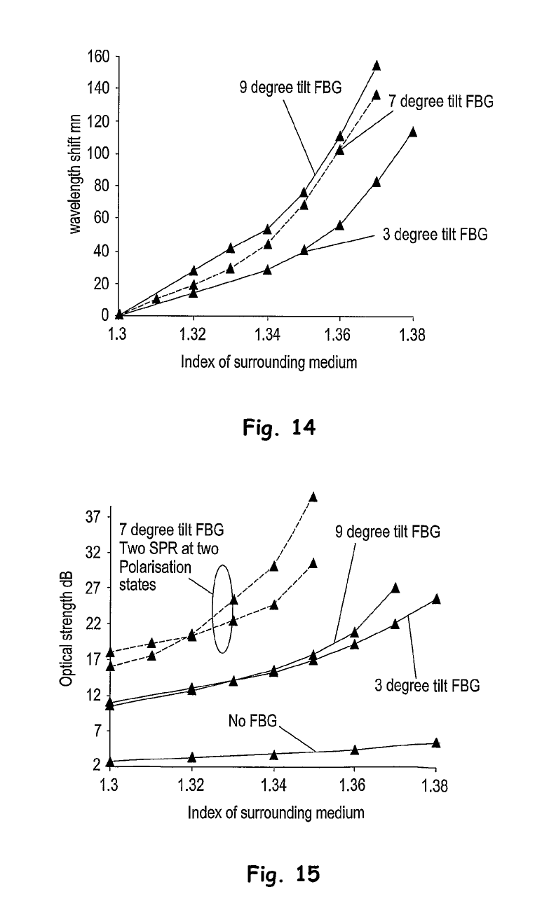

FIG. 14 graphically illustrates the dependence of changes in the spectral position of attenuation resonances of the transmission spectrum such as is illustrated in FIG. 8, upon the refractive index of the sample solution being sensed, and with a surface Plasmon generator employing a tilted fibre Bragg grating having a tilt angle of 3 degrees, 7 degrees or 9 degrees;

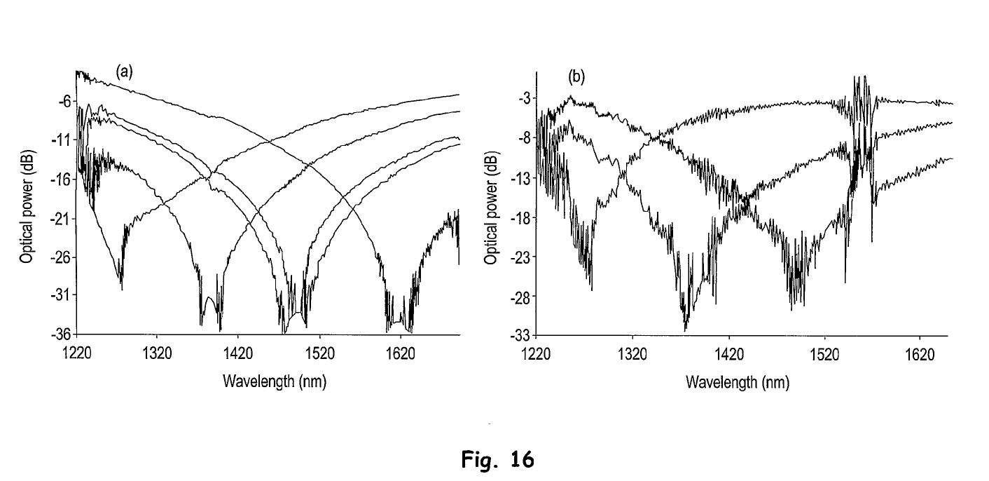

FIG. 15 graphically illustrates the dependence of the strength of the attenuation resonances such as shown in FIG. 8, upon the refractive index of the sample solution being sensed, using a surface Plasmon generator including a tilted fibre Bragg grating having a tilt angle of 3 degrees, 7 degrees or 9 degrees. Also shown, for comparison, is the result when no fibre Bragg grating is employed in the surface Plasmon generator;

FIG. 16 graphically illustrates attenuation resonances in the spectrum of a transmitted optical signal by the surface Plasmon generator of FIG. 5, and resulting from the input thereto of optical signals having different polarisation sates;

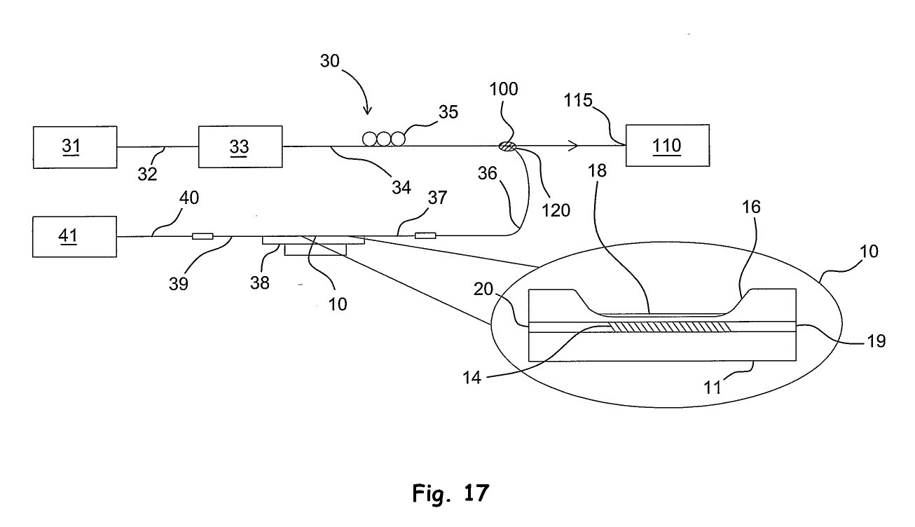

FIG. 17 schematically illustrates a sensor employing a surface Plasmon generator according to an example of the invention;

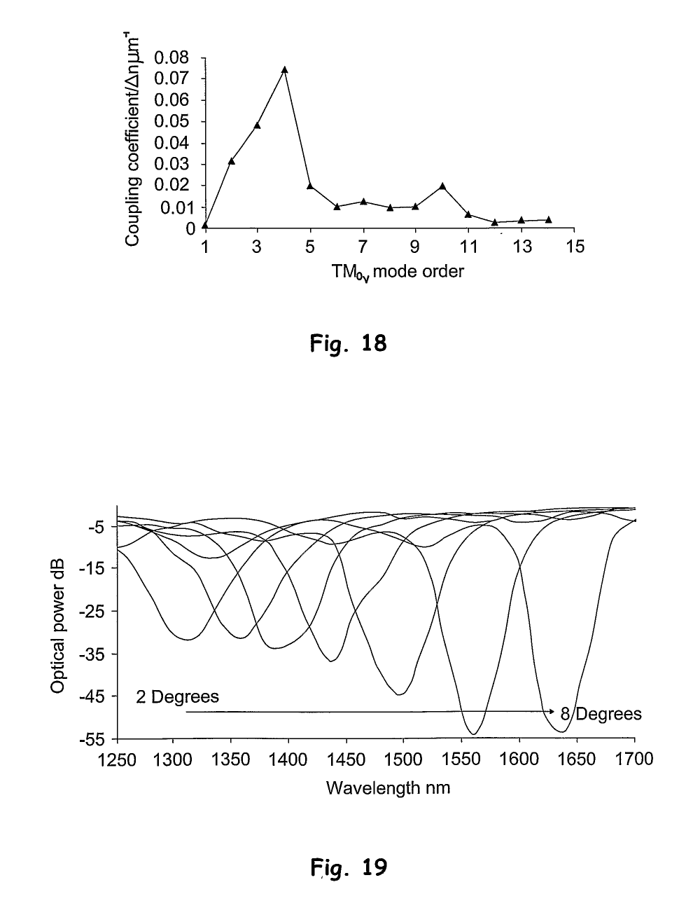

FIG. 18 graphically shows the coupling coefficients of optical radiation modes as a function of mode number;

FIG. 19 graphically shows predicted optical power spectra for a surface Plasmon generator for a series of different polarisation states in the radiation illuminating the generator;

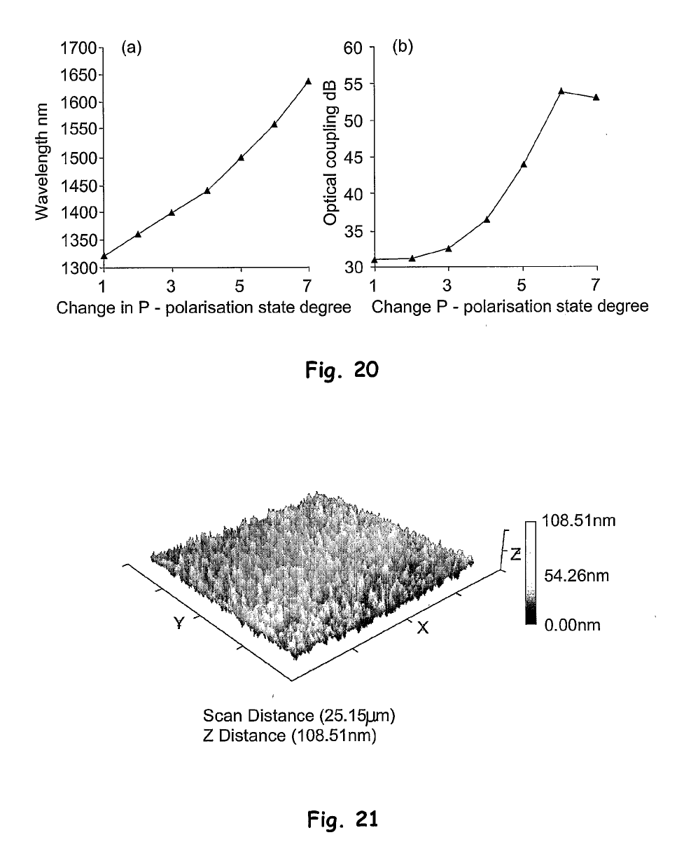

FIG. 20 graphically shows predicted wavelength dependence in the spectral position of a surface Plasmon resonance (FIG. 20(a)) of a surface plasmon generator as a function of the p-polarisation angle of illuminating radiation, and the predicted optical coupling strength for the surface Plasmon resonances(FIG. 20(b)) for a series of different polarisation states in the radiation illuminating the generator;

FIG. 21 shows an AFM image of a silver surface formed on the flat of the D of a lapped fibre illustrated in FIG. 5;

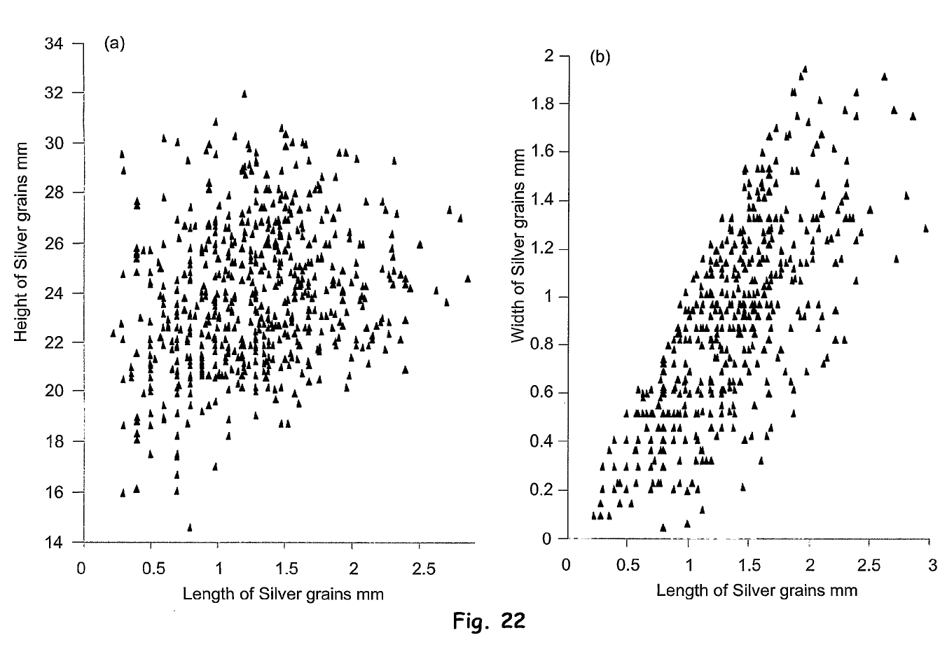

FIG. 22 shows the measurements of the dimensions (length, height and width) of grains of the silver layer of FIG. 21;

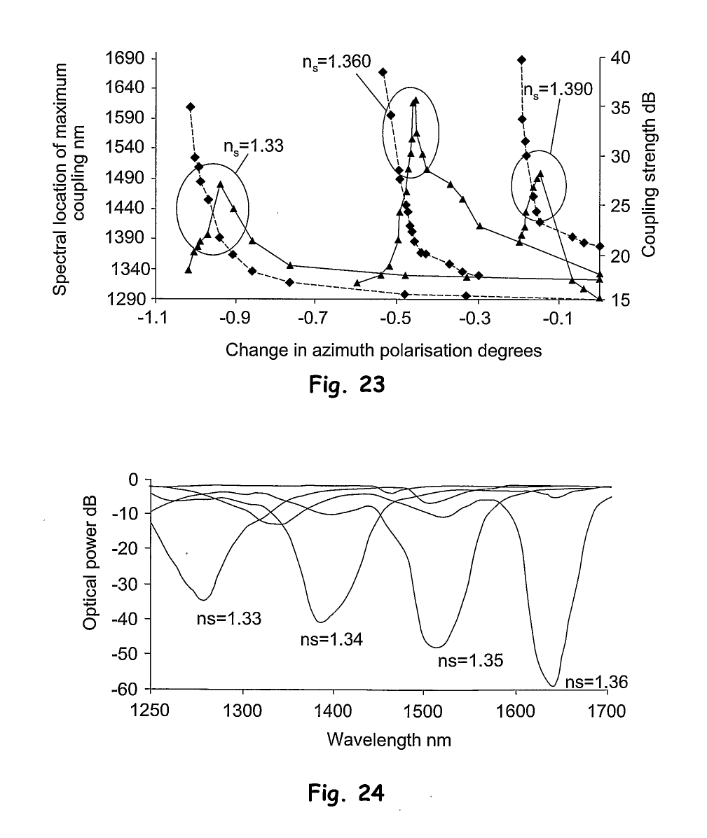

FIG. 23 shows the measured dependence of the SPR coupling strength (solid lines) and the spectral location of the SPR (dashed lines) of the device of FIG. 5 when immersed in each of three different substances having different refractive indices;

FIG. 24 shows predicted optical power spectra for a variety of refractive indices sensed substances;

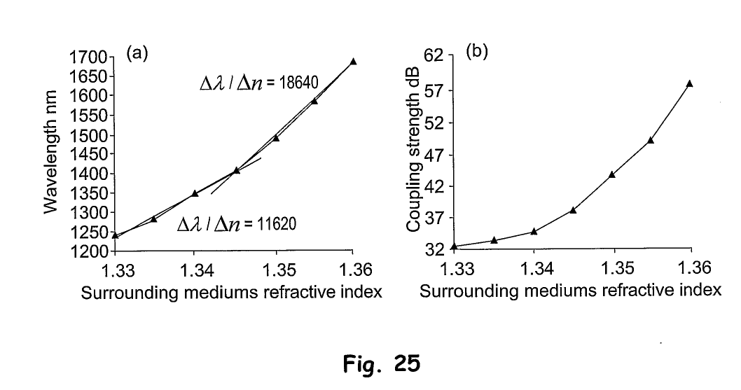

FIG. 25 shows predicted wavelength (FIG. 25(a)) and coupling strength (FIG. 25(b)) sensitivities of a simulated surface plasmon generator to variations in refractive index of the sensed substance;

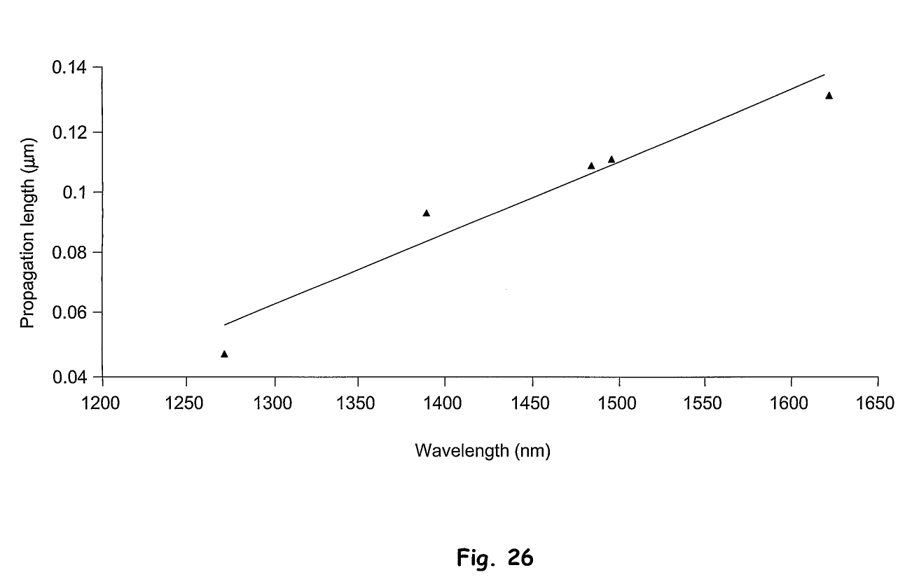

FIG. 26 graphically shows the variation of the propagation length of a surface Plasmon generated on a generator illustrated in FIG. 5 by coupling to illuminating radiation having a each of a variety of wavelengths.

In the drawings, like items are assigned like reference symbols. The terms attenuation resonance, and surface Plasmon resonance (SPR) are intended to be synonymous.

Referring to FIG. 5 there is schematically illustrated, in cross section, an example of a surface Plasmon generator 10 according to an example of the present invention. The surface Plasmon generator includes a length of optical fibre 11 having an optical signal input part 19 comprising an open end of the optical fibre length arranged for receiving optical signals into the optical fibre, and an optical output part 20 comprising an open end of the optical fibre from which output optical signals can be received from the optical fibre.

The optical fibre has an optical fibre core part 13 clad by an optical fibre cladding 12. The diameter of the core part, and the dimensions, structure and design of the optical fibre as a whole, are such as to render the optical fibre a single-mode optical fibre in respect of optical signals having a wavelength in excess of about 1000 nanometres (as measured in vacuo).

The cladding part of the optical fibre is lapped 16 to define a proximal outer surface area 17 which is closer to the core part 13 than are other adjacent outer surface areas (un-lapped) of the cladding part 12. The proximal outer surface area 17 formed by lapping the cladding part defines a substantially flat outer surface area of the cladding part nearmost, but not exposing, a length of the underlying core part 13 of the optical fibre. The substantially flat proximal outer surface area is in a plane generally parallel to the axis of the optical fibre such that points upon the proximal outer surface forming a line parallel to the longitudinal (i.e. transmission) axis of the optical fibre are each equally spaced from the optical fibre core part 13.

A film of silver 18 is coated upon the substantially flat proximal outer surface area 17 in the lapped region 16 of the cladding part of the optical fibre. The silver coating is of uniform thickness of 35 nm and is substantially flat. It is in direct contact with, and forms an interface with, the flat proximal surface area of the fibre cladding and, at its outward surface 18 opposite the interface, the silver layer outwardly presents from the optical fibre a substantially flat and exposed silver surface which extends over the interface in question.

The core part 13 of the optical fibre includes a tilted fibre Bragg grating 14 comprising a sequence of refractive index modulations 15 each of which extends across the optical fibre core part to form a plane area of common (modulated) refracted index which obliquely faces both the interface between the proximal surface area 17 of the fibre cladding part and the silver coating 18 thereupon, and the input end 19 of the optical fibre. The result is to render the interface 17 between the proximal surface of the lapped cladding, and the overlying silver layer 18, simultaneously in optical communication with the input end 19 of the optical fibre by reflection 22 of at least a part of an input optical signal directed into the surface Plasmon generator via the input part 19 of the optical fibre 11. The reflected part 22 of the input optical signal may be employed in generating surface plasmons at the outwardly presented surface 18 of the silver layer arranged upon the proximal outer surface of the fibre cladding.

The optical processes and modes generated by the tilted fibre Bragg grating 14 within the core of the optical fibre 11 may be analysed, to a first order of approximation, using the so-called Volume Current Method with which the skilled addressee will be familiar. Although the following analysis does not take account of the lapped region 16 of the fibre cladding 12 of the optical fibre, it is useful for an understanding of the optical processes which may be occurring in the surface Plasmon generator 10 of the present embodiment.

Consider an optical input signal 21 input into the optical fibre 11 at the input part 19. Upon reaching the tilted fibre Bragg grating 14 of the optical fibre, a part 22 of the input optical signal is reflected by the Bragg grating, and a part 23 and is transmitted by the Bragg grating to be ultimately output via the output part 20 of the optical fibre. The interaction between counter-propagating reflected parts and transmitted parts of the optical signal within the tilted fibre Bragg grating supports the generation of radiative optical modes which are coupled to the guided (i.e. core) optical modes by the Bragg grating.

The wave vector component (Δkₓ) parallel to the fibre axis which is imparted to the radiative modes 22 reflected by the Bragg grating's refractive index modulations 15 is:

$$Δ {k}_{x} = {k}_{0} {n}_{eff} - \frac{2 π}{Λ} cos ( {ξ}_{G} )$$

Where k₀ is the wave vector of the optical signal in free space, n_{eff} is the effective refractive index experienced by the optical signal in the core mode within the optical fibre, Λ is the grating period (spacing between successive refractive index modulations) of the tilted fibre Bragg grating, and ξ_{G} is the angle of tilt of the planes of refractive index modulation relative to the diameter of the optical fibre core of refractive index n_{core}. The radiative modes 22 reflected from the tilted grating have imparted to them, by the grating, a wave vector component transverse to the axis of the optical fibre which causes the radiative modes 22 to travel back along the fibre obliquely in a direction which would lead them to exit the optical fibre at a “tap angle” ξ given by:

Δkₓ=k₀n_{core} cos(ξ)

This relation can be expressed in terms of tilted fibre Bragg grating parameters as:

$$cos ( ξ ) = \frac{1}{{n}_{core}} [ {n}_{eff} - \frac{λ}{Λ} cos ( {ξ}_{G} ) ]$$

Where λ is the wavelength of the optical signal in vacuo. The Bragg grating period may be about 0.5 μm, but other optimal values may be used.

It is to be understood that in the above analysis the presence of the lapped region 16 in the cladding of the optical fibre 11 of the surface Plasmon generator is not accounted for. The lapped region will have a dramatic effect upon the “tap angle” at which radiative modes of optical signals within the fibre impinge upon the interface formed between the proximal surface area 17 of the cladding 12 of the optical fibre, and the overlaying silver coating 18 upon the outwardly presented (exposed) surface of which surface plasmons are thereby generated.

In this way, the back-reflection of input optical signals incident upon the tilted fibre Bragg grating enables the grating to generate coupled radiative optical modes which impinge upon the silver coating 18 of the surface Plasmon generator 10 and thereupon resonantly generate surface plasmons when the wave vector component of the radiative modes which is parallel to the fibre axis, matches the wave vector of surface plasmons excitable at that silver surface. As a result of this resonant coupling between radiative modes and surface plasmons, and in consequence of the optical coupling, by the Bragg grating, between the radiative modes and the guided core modes of optical signals within the optical fibre 11, it has been found that resonant coupling of surface plasmons and radiative optical modes influences the intensity of guided core optical modes 23 transmitted through the tilted Bragg grating and ultimately output from the output part 20 of the surface Plasmon generator. This relationship may manifest itself as a transmitted output signal intensity attenuation within the optical spectrum of output signals 23. It has been found that the wavelength at which optical signal attenuation is greatest, and/or the strength/depth of output signal attenuation, is dependent upon the refractive index of any substance present at the exposed outwardly presented surface of the silver layer 18 upon which surface plasmons propagate and transversely to which (i.e. in to the adjacent substance) the electro magnetic field of these surface plasmons will extend. This property of the surface Plasmon generator of FIG. 5 may be exploited in a sensor device (e.g. a biochemical sensor device) such as is illustrated in FIG. 6 as follows.

FIG. 6 graphically illustrates a sensor device comprising a broadband infra-red optical signal source 31 arranged to generate optical signals within the range 1000 nm to 2000 nm and to output such optical signals to an optical signal polariser unit 33 placed in optical communication with broadband optical signal source via a linking optical fibre 32. The polariser unit 33 is arranged to produce from input optical signals received thereby from the optical signal source 31, output optical signals of a pre-determined state of polarisation, and to output the polarised optical signals to a polarisation controller 35 with which the polariser is in optical communication via an intermediate length of optical fibre 34. The polariser unit includes a length of optical fibre mechanically twistable, or twisted, by a predetermined amount to induce a birefringence in the material of the fibre and a corresponding change in the polarisation state of the optical radiation transmitted through it.

The optical output of the polarisation controller 35 is in optical communication with the input part 19 of the surface Plasmon generator 10 via an intermediate length of optical fibre 36 and a bare-fibre connector portion 37. The output part 20 of the surface Plasmon generator 10 is in optical communication with the optical input of an optical spectrum analyser 41 via an intermediate bare-fibre connector 39 and length of optical fibre 40. Ends of both of the aforementioned bare-fibre connectors (37, 39) are optically coupled directly to the input and output parts of the surface Plasmon generator.

In use optical signals generated by the optical signal source 31 are output thereby to the polariser unit 33 which produces therefrom a polarised optical signal for input to the polarisation controller 35 which is operable to adjust to the state of polarisation of the received polarised optical signal as required, and to subsequently output the polarised optical signal to the optical input part 19 of the surface Plasmon generator 10 for use in generating surface plasmons as discussed above with reference to FIG. 5. Those parts of the polarised optical signal input to the surface Plasmon generator which are transmitted through the tilted fibre Bragg grating 14 thereof are subsequently output at the output part 20 of the surface Plasmon generator and are input to an optical input of the optical spectrum analyser 41 whereat the intensity and wavelength of the transmitted optical signal is measured. Subjecting the surface Plasmon generator to optical signals of a wide range of differing wavelengths within the spectrum of the broadband optical signal source 31, enables a transmitted optical signal spectrum to be generated in respect of the transmitted optical signal 23 output by the surface Plasmon generator. Examples of such spectra are discussed below.

The sensor device 30, illustrated in FIG. 6, also includes a sample control unit 38 in the form of a vessel containing a sample substance (e.g. aqueous solution) within which the surface Plasmon generator 10 is immersed and to which the outwardly presented silver surface 18 of the surface Plasmon generator is exposed.

FIG. 7 illustrates representative examples of the transmission spectrum of the surface Plasmon generator in which the tilted fibre Bragg grating has a tilt angle of 7 degrees, and is immersed within a sample solution having a refractive index of 1.360. Several spectra are illustrated and each one corresponds to a spectrum produced at a respective one of five different states of polarisation of the optical signal 21 input into the surface Plasmon generator 10. The optical power of the optical signal 23 transmitted by the surface Plasmon generator is graphically presented as a function of the wavelength of the optical signal in question. Surface plasmon resonances are identified by the presence of transmitted signal intensity attenuation resonances (50, 51) in each of the five spectra illustrated. Thus, it has been found that the spectral position (i.e. wavelength) at which surface plasmon resonances occur in the surface Plasmon generator may be tuned by appropriately tuning the state of polarisation of the plasmon-exciting optical signal. FIG. 7 illustrates that the surface Plasmon generator is able to generate surface plasmon resonances over a large spectral range from 1200 nm to 1700 nm, whilst the device is submerged in test sample fluids. Surface plasmon resonances, and spectral attenuation resonances, have also been generated using illuminating light of wavelengths as low as 600 nm (e.g. in the range 600 nm to 900 nm, or above) using this arrangement.

FIGS. 8 and 10 graphically illustrate the response of the spectrum of the transmitted optical signal 23 in a fixed state of polarisation, but with the surface Plasmon generator 10 immersed in a number of different sample solutions each having a different refractive index value in the range 1.3 to 1.37. Referring to FIG. 8, the state of polarisation of the input optical signal employed in the production of these results illustrates that, by an appropriate choice of polarisation state, the sensor device may be tuned to cause the spectral position (i.e. wavelength) of the spectral attenuation resonance to be dependent upon the refractive index of the sample being sensed. The spectral position of the centre of the attenuation resonance was found to increase to higher wavelength values as the refractive index of the sample increased. This is to be contrasted with the spectra illustrated in FIG. 10 in which the state of polarisation of illuminating radiation was changed from that employed in producing the spectra illustrated in FIG. 8, having been tuned such that the spectral position of the attenuation resonances became insensitive to changes in the refractive index of the samples. However, as is the case in respect of the spectra illustrated in FIG. 8, the strength/depth of the attenuation resonances on the spectra of FIG. 10 increases with increasing refractive index of the sample. In the spectra illustrated in FIGS. 8 and 10, the arrow 60 indicates that the lower the vertical position of a given spectrum within the graph, the greater the refractive index of the sample employed in generating that spectrum. FIG. 11 graphically illustrates the dependence upon the sample refractive index of the optical strength/depth of the spectral attenuation resonances illustrated in FIG. 10.

Thus, FIGS. 8 to 11 illustrate that both the spectral position of an attenuation resonance, and/or the depth/strength of the resonance is a measure of the refractive index of the sample being sensed by the surface Plasmon generator 10 of the sensor device referred to and illustrated in FIG. 6. The state of polarisation of the illuminating radiation may be tuned in order to tune and adjust the sensitivities and characteristics of the surface Plasmon generator and the sensor in question.

FIGS. 12 and 13 show further examples of this relationship between properties of the optical spectrum of the transmitted optical signal 23 output by the surface Plasmon generator, and FIG. 12 graphically illustrates the change (shift) in the spectral position (wavelength) of spectral attenuation resonances illustrated in FIG. 8, as a function of a sample's refractive index. The shift in attenuation resonance position is found to be an approximately linear function of the refractive index of the sample being sensed over two distinct ranges of refractive index. This results in a maximum spectral sensitivity of the device 30 of Δλ/Δn=3100 nm of the refractive index range of 1.335 to 1.370, corresponding to a refractive index resolution of about 3×10⁻⁵ assuming a sensitivity of Δλ=0.1 nm in the measurement of the positions of spectral attenuation resonances. In the range of refractive indices of 1.300 to 1.335, the spectral sensitivity is about Δλ/Δn =1078 nm corresponding to a refractive index resolution of about 9×10⁻⁵ assuming a sensitivity of Δλ=0.1 nm in the measurement of the positions of spectral attenuation resonances.

This parameterisation of sensitivities of attenuation resonance position, as a function of sample refractive index value, is useful as a means of analysing the properties of the sample being sensed by the surface Plasmon generator 10. Embodiments of the invention may comprise signal processor apparatus adapted to measure the spectral position and/or strength/depth of attenuation resonances identified in the optical spectrum of transmitted optical signals 23 output by the surface Plasmon generator, and input to the optical spectrum analyser 41 of the sensor device 30 illustrated in FIG. 6. The signals to which the signal processor is responsive may be electrical signals generated by the optical spectrum analyser 41 representative of the optical spectrum in question. The signal processor may be operable or arranged to indicate the refractive index of a sample being sensed, or a change in the refractive index thereof, according to the spectral position, or a change in the spectral position, of an attenuation resonance in such an optical spectrum. The signal processor may be (or include) a computer (e.g. a PC) which may be programmed to put effect to the above analysis of spectra.

In this way, the sensor device 30 illustrated in FIG. 6 may be employed as a sample analysis device for analysing samples such as aqueous solutions or biochemical solutions.

FIG. 14 illustrates the sensitivities of the surface Plasmon generator of FIG. 6, to changes in the refractive index of substance being sensed thereby, for three different configurations of tilted fibre Bragg grating 14. In each case, the optical radiation passed through the Bragg grating was prepared with a state of polarisation which caused the wavelength position of the spectral attenuation resonance (SPR) of the grating to shift in dependence upon the refractive index of the sample substance being sensed by the device. The dependent variable in the graph of FIG. 14 is the shift in the wavelength position of the centre of the SPR measured relative to its position when the sample refractive index is 1.3 in value.

In a first configuration, the tilted fibre Bragg grating had a tilt angle of 7 degrees, as described above, and resulted in a spectral attenuation resonance (SPR) as discussed with reference to FIGS. 8 and 9. The curve representing SPR position as a function of sample refractive index illustrated in FIG. 9 is, therefore, reproduced in the SPR wavelength-shift.vs.sample-refractive-index graph of FIG. 14.

In a second configuration, a Bragg grating with a tilt angle of 3 degrees, instead of 7 degrees, was employed. The sensitivity of the device is seen to be lower, with changes in sample refractive index producing less change in attenuation resonance (SPR) position, as compared to that when the tilt angle of the Bragg grating was 7 degrees.

In a third configuration, a Bragg grating with a tilt angle of 9 degrees, instead of 7 degrees or 3 degrees, was employed. The sensitivity of the device is seen to be higher, with changes in sample refractive index producing a greater change in attenuation resonance (SPR) position, as compared to that when the tilt angle of the Bragg grating was either 7 degrees or 3 degrees. It can be seen that, when an embodiment is employed (e.g. radiation polarisation state tuned) in which sample refractive index is sensed according to spectral attenuation resonance (SPR) position, then, of the three configurations discussed above, the third, with a tilted fibre Bragg grating having a tilt angle of 9 degrees, produces the greatest spectral sensitivity. That spectral sensitivity reaches Δλ/Δn=3365 nm in the range 1.34 to 1.38 of sample refractive index, leading to a refractive index resolution of about 2×10⁻⁵ assuming a 0.1 nm resolution in the measurement of attenuation resonance positions.

FIG. 15 illustrates the sensitivities of the surface Plasmon generator of FIG. 6, to changes in the refractive index of substance being sensed thereby, for a further three different configurations of tilted fibre Bragg grating 14. In each case, the optical radiation passed through the Bragg grating was prepared with a state of polarisation which caused the wavelength position of the spectral attenuation resonance (SPR) to remain substantially unchanged in dependence upon the refractive index of the sample substance being sensed by the device. The dependent variable in the graph of FIG. 15 is the optical strength (depth) of the centre of the spectral attenuation resonance of the grating.

In a first further configuration, the tilted fibre Bragg grating had a tilt angle of 7 degrees, as described above, and resulted in a spectral attenuation resonance as discussed with reference to FIGS. 10 and 11. The curve representing the optical strength of the attenuation resonance as a function of sample refractive index illustrated in FIG. 11 is, therefore, reproduced in the graph of FIG. 15. A similar curve is shown illustrating the response of the device to a change in the state of polarisation of the optical radiation transmitted through the tilted fibre Brag grating. This illustrates the sensitivity of the device to changes in the state of polarisation of the illuminating radiation.

In a second further configuration, a Bragg grating with a tilt angle of 3 degrees, instead of 7 degrees, was employed. The sensitivity of the device is seen to be lower, with changes in sample refractive index producing less change in attenuation resonance strength, as compared to that when the tilt angle of the Bragg grating was 7 degrees.

In a third further configuration, a Bragg grating with a tilt angle of 9 degrees, instead of 7 degrees or 3 degrees, was employed. The sensitivity of the device is seen to be higher than that attained when tilt angle was 3 degrees, but less than that attained when tilt angle was 7 degrees. Changes in sample refractive index produce a change in attenuation resonance strength which is intermediate that attained when the tilt angle of the Bragg grating was either 7 degrees or 3 degrees. Finally, FIG. 15 illustrates, for the purposes of comparison, the sensitivity of a modified version of the surface Plasmon generator in which no fibre Bragg grating is employed. This illustrates that the presence of a tilted Bragg grating in the surface Plasmon generator has a dramatic effect upon the ability of the device to generate surface plasmons.

The spectral sensitivity, Δλ/Δn, of various embodiments and configurations of the sensor device 30 concerned with shifts in spectral attenuation resonance (SPR), was found to vary from 700 nm to 1400 nm over a range of sample refractive index values of 1.3 to 1.34, and to vary from 2100 nm to 3400 nm over a range of sample refractive index values of 1.34 to 1.38. In embodiments and configurations concerned with changes in optical strength (depth) of attenuation resonances, the sensor device yielded optical strengths of 106 dB to 300 dB over the index regime of 1.3 to 1.34, and 250 dB to 730 dB over the index regime of 1.34 to 1.38.

Comparing the coupling strength of the transmission attenuation resonances both with and without a Bragg grating present in the surface Plasmon generator of the sensor device (FIG. 15), it can be seen that the presence of a Bragg grating greatly enhances the coupling of optical radiation to surface plasmons, in the aqueous-sample refractive index regime, from ˜4 dB depth of transmission attenuation resonance without grating (corresponding to a sensitivity of d(dBm)/dn=30 dB), to 25 dBs depth of resonance when a 7 degree tilted grating is incorporated. This is a 25 fold increase in sensitivity. Coupling of radiation to surface plasmons increases, with increasing surrounding index, to produce spectral attenuation resonances having a strength in excess of 35 dB when sample refractive index exceed 1.36.

The surface Plasmon generator may be constructed in three stages. First, a tilted Bragg grating is written into the core of a UV photosensitive clad single mode fibre by UV inscription, the grating being tilted to a specific tilt angle. Labels may be added to indicate the orientation of the tilted grating. Second, a specific part of the fibre cladding is lapped down to e.g. 10 μm of the core-cladding interface. The labels on the fibre (if used) may be used to determine which region of cladding is to be removed such that the Bragg grating tilt angle relative to the flat of the lapped fibre is the same orientation as the tilt angle relative to the axis of the fibre. Third, the flat of the lapped fibre is then coated with silver (e.g. to a uniform thickness of 35 nm) using, for example, a sputter machine and mask.

The sensor device may employ a broadband light source which directs optical signals to first pass through a polariser and a polarisation controller before illumination of a sample therewith, and the transmission spectra may be monitored using an optical spectrum analyser having a resolution of e.g. 0.005 nm.

Observations can be made concerning the data illustrated in the figures as follows. First, that the spatial extension of the surface Plasmon electromagnetic fields are varying from 1.11 μm to 1.97 μm at the same spatial location, with a propagation length reaching ˜300 μm for a smooth silver coating, falling to as low as about 40 nm for a rough metal coating surface.

For refractive index sensitivity measurements the surface Plasmon generator was placed in a V-groove and immersed in certified refractive index (CRI) liquids (supplied by Cargille laboratories Inc.) which have a quoted accuracy of ±0.0002. The surface Plasmon generator and V-groove were carefully cleaned, washed in ethanol, and then in deionised water, and finally dried before immersion into a given CRI liquid. The V-groove was made in an aluminium plate, machined flat to minimise bending of the fibre. The plate was placed on an optical table, which acted as a heat sink to maintain a constant temperature.

This invention may also have applications in the field of Cell-Biology as a tool in the investigation of Cell-Scaffolding and how cells interact with various support media, as well as in studies into cell relationships with surfaces.

The present invention may be employed as a tool for interrogating reactions for the Bio-chemical industry. Also, the ability to tune the spectral attenuation resonances means that the spatial extension of the surface plasmon fields can be varied at a given spatial location and can be used to penetrate various distances from metal surface upon which it is formed. This permits investigation of chemical/physical properties of thin films.

For example, the use of a tilted fibre grating to assist the generation of localised infra-red surface Plasmons with short propagation lengths is discussed below. A sensitivity to changes in the refractive index in a measurand of Δλ/Δn=3365 nm is demonstrated in the aqueous regime. It is also demonstrated that the surface Plasmon resonances (SPR) may be spectrally tuned over a range of the order of 1000 nm in the wavelength of the optical radiation used to illuminate the surface Plasmon generator. This tuning may be achieved by altering the state of polarisation of the light illuminating the generator (e.g. polarisation angle, azimuth or ellipticity). A high coupling efficiency (in excess of 25 dB) is achieved. This is found to occur in respect of surface Plasmons (SPs) located at the same spatial region of the surface Plasmon generator.

The majority of existing SPR-based systems operate in the visible or near infra-red part of the optical spectrum. This typically gives a surface Plasmon a probing depth (i.e. the spatial extension of the surface Plasmon transversely from the surface of the metal and into the surrounding environment) of around 200 nm to 300 nm. The SPs exist at a metal-dielectric interface and obey the following dispersion relation for two homogeneous semi-infinite media:

$$β = {k ( \frac{{ɛ}_{m} {n}_{s}^{2}}{{ɛ}_{m} + {n}_{s}^{2}} )}^{1 / 2} = {kn}_{2} sin ( ϕ ) \qquad ( 1 )$$

where k is the free space wave number, εₘ is the permittivity of the metal (εₘ=Cₘᵣ+iεₘᵢ) and nₛ is the refractive index of the sample to be tested. In the present example, when a lapped optical fibre is employed, the quantities appearing on the right of expression (1) are as follows: n₂ is the refractive index of the cladding of the optical fibre, and φ is the angle of incidence of illuminating radiation on to the metal/dielectric interface (this determines the wave-number projection onto that interface).

The use of a tilted fibre grating (such as a TFBG) as discussed above, enhances the coupling of the illuminating light to a SP generated on the metal (e.g. silver) coating applied to the dielectric and forming the interface (e.g. a lapped single mode fibre in examples given above). It is observed that the spectral location of maximum coupling of the illuminating light to the SP is dependent upon the polarisation state of the illuminating light and that this coupling can be tuned over a at least wavelength range of 100 nm to 1700 nm of the light.

An analysis both of experimental data, and calculations performed to analyse them, points to a conclusion that the propagation length of surface plasmons generated according the invention is short (e.g. of the order of ˜100 nm) as compared to their spatial extension (probe depth) transverse to the surface of the metal supporting the plasmons, which is in excess of 1.0 μm, and may be between about 1.0 μm and 2.0 μm (e.g. around 1.5 μm).

A spectral index-measurement sensitivity (Δλ/Δn) of 3365 nm may be achieved for the surface Plasmon generator described above in respect of measured samples with a refractive index in value from range 1.335 to 1.370 (suitable for refractive index monitoring of aqueous solutions), and for SPs generated using illuminating radiation having a wavelength in at least the range 1200 nm to 1700 nm.

A series of devices was fabricated, being of the type discussed above with reference to FIG. 5, with angles of tilt from 1° to 9°. It was possible to generate SPRs with all of them. For a given device it was possible to produce SPRs over a large spectral range from 1200 nm to 1700 nm, whilst the device was submerged in test sample fluids, as shown in FIG. 16 (note that the features seen at maximum coupling of the SPR are artefacts caused by the normalisation procedure of the optical spectrum analyser employed in generating the data, and that the maximum coupling bandwidth can be considerably narrower).

FIG. 16 shows the transmission spectra of a surface Plasmon generator device (such as shown in FIG. 5) when illuminated with linearly (or elliptically) polarised light of various polarisation angles. FIG. 16(a), as well as FIG. 7, corresponds to the device in a solution with an index of 1.360 (Ag thickness 35 nm, tilt angle 7°, length 2.8 cm). FIG. 16(b) corresponds to the device in a solution with an index of 1.380 (Ag thickness 35 nm, tilt angle 30, length 5.0 cm).

The dependency of these SPR devices upon the state of polarisation of the illumination radiation was investigated using the apparatus schematically illustrated in FIG. 17. This comprises the apparatus of FIG. 6 further including a polarisation-maintaining coupler 100 coupled to the optical line 36 between the polarisation controller 35 and the lapped fibre 10, and arranged to sample a portion of light propagating along the optical line from the optical signal source 31 to the lapped fibre. The sampled, polarised radiation is directed a polarimeter 110 having an optical input 115 in optical communication (via a fibre) with an optical output 120 of the polarisation-maintaining coupler 100. In this way, the polarimeter is arranged to measure the state of polarisation of the radiation illuminating the lapped fibre 10. This may include measuring the polarisation angle (e.g. azimuth) of linearly or elliptically polarised light produced by the polariser and polarisation controller (33, 35).

A given surface Plasmon generator device was submerged into various index-matching solutions, and its transmission spectrum (optical power spectrum) was measured for a series of different values of the polarisation angle of linearly (or elliptically) polarised illuminating light. The maximum extinction (i.e. depth of the SPR feature in the optical power spectrum), induced by the coupling of the polarised illuminating radiation to the SP it generated, is very much dependent upon the polarisation state of the illuminating light. This is an unexpectedly high coupling.

However, whilst variations of the strength of the SPRs occur with changes in polarisation, the surface Plasmon generating devices still produce large extinction ratios over the wavelength range studied. For example, in FIG. 16 (and FIG. 7) it can be seen that over the observed spectral range (1220 nm to 1700 nm), the device with a 7° degree grating tilt angle exhibits extinction ratios in excess of 35 dB in a solution with a refractive index of 1.360. Furthermore, it can be seen from FIGS. 16 and 7 that the extinction range of these devices ranges from around 1 dB to 35 dB for a given wavelength, as a function of polarisation state.

Changing the tilt angle of the fibre Bragg grating changes the maximum extinction ratio achievable when altering the polarisation state of the illuminating light, as shown in FIG. 14 and FIG. 15. Comparing the coupling strength of the SPR with and without a grating (FIG. 15), it can be seen that the grating greatly enhances the SPR coupling in the aqueous index regime from ˜4 dB without grating to 25 dB for the 7 degree tilted grating with coupling increasing with increasing surrounding index to in excess of 35 dB. Spectral features in a fibre device with no grating were very much broader than those associated with a corresponding device with a grating present.

A spectral sensitivity of Δλ/Δn=3365 nm is achievable. Such sensitivity may result in a resolution (under the assumption of a 0.1 nm measurement resolution for the resonance wavelength) of ˜2×10⁻⁵ over the index range of 1.34 to 1.38 (e.g. in the device containing a 9 degree tilted grating). For the sensor devices investigated to date, the spectral sensitivities (Δλ/Δn) may vary from 700 nm to 1400 nm over the index range of about 1.3 to 1.34 and from 2100 nm to 3400 nm over the index range of about 1.34 to 1.38. Optical power variations for the sensor devices may vary from about 106 dB to 300 dB over the index range of about 1.3 to 1.34 and from about 250 dB to 730 dB over the index range of about 1.34 to 1.38. The sensor device containing a 7 degree tilted grating may achieve the strongest coupling of illuminating radiation to a SP, resulting in SPRs having strengths/depths varying from 10 dB to +30 dB in the aqueous index regime.

FIGS. 14 and 15 show the spectral characteristics of three devices containing fibre gratings with three different tilt angles: 3 degrees, 7 degrees and 9 degrees. The two curves associated with a 7 degrees tilt angle correspond to two different states of polarisation (angle of polarisation in linearly or elliptically polarised light) of illuminating radiation incident upon the grating in question. FIG. 14 illustrates the resonance wavelength shift and FIG. 15 illustrates the variation of the strength of a given resonance as a function of the surrounding medium's refractive index. Also shown as a control in FIG. 15 is the coupling strength of a lapped and coated fibre containing no grating.

It is possible to reproduce theoretical optical transmission spectra which are similar to those of the sensor device when employed using illuminating radiation comprising p-polarised light. A model was produced for the SPR fibre devices described above by firstly calculating the scattering angles associated with the various transverse modes (TE/TM) propagation constants generated by a D-shape fibre with a silver coating. The scattering angle (φ) is calculated from the refractive indices associated with the propagation constants of the cladding modes (n_{β}) by a relationship given by the well known “ray approach”, whereby cos(φ)=n_{β}/n_{cl} and n_{cl} is the refractive index of the cladding, this angle being relative to the fibre axis. These angles were used to give an associate incident angle (φ) of each cladding mode onto the metal/dielectric interface and thus the cladding mode wave-number projection onto that interface. Surface plasmons are generated when this wave-number projection matches the dispersion relation of the plasmons given by expression (1) above, thus:

$$\frac{2 π}{λ} {( \frac{{ɛ ( λ )}_{m} \cdot {n ( λ )}_{s}^{2}}{{ɛ ( λ )}_{m} + {n ( λ )}_{s}^{2}} )}^{1 / 2} = \frac{2 π \cdot {n}_{cl}}{λ} sin ( ϕ ) \qquad ( 2 )$$

The theoretical spectral transmission response of the SPR fibre device is obtained by calculating the reflected intensity of the fibre device at various wavelengths. The quantitative description of the minimum of the reflected intensity R for a SPR can be given by Fresnel's equations for a three layered system. This was done by implementing Fresnel's equations for a three layered system for different refractive indices of the surrounding medium. The reflectivity R of the silver coating at various wavelengths of p-polarised light, with EP the incoming field and EP the reflected field, is given by

$$R = {\vert \frac{{E}_{r}^{p}}{{E}_{0}^{p}} \vert}^{2} = {\vert \frac{{r}_{{n}_{2} {n}_{m}}^{p} + {r}_{{n}_{2} {n}_{s}}^{p} exp ( 2 i {k}_{{zn}_{m}} d )}{1 + {r}_{{n}_{2} {n}_{m}}^{p} {r}_{{n}_{m} {n}_{s}}^{p} exp ( 2 i {k}_{{zn}_{m}} d )} \vert}^{2} \qquad ( 3 )$$

where d is the thickness of the metal coating, and

$${r}_{i , l}^{p} = ( \frac{{K}_{z , i}}{{ɛ}_{i}} - \frac{{K}_{z , j}}{{ɛ}_{j}} ) / ( \frac{{K}_{z , i}}{{ɛ}_{i}} + \frac{{K}_{z , j}}{{ɛ}_{j}} )$$

is the p-polarisation amplitude reflection coefficient between layers i and j and the K_{z,i} and K_{z,j} are the wave vector components of the illuminating incident light normal to the layer i or j (for details see H. Raether: “Surface Plasmons on smooth and Rough Surfaces and on Gratings”; Springer Verlag, ISBN 3-540-17363-3—see Appendix A, and equation A.16).

The polarisation dependence is simplistically incorporated into the Fresnel's equations by the introduction of sin(δ) (δ=π/2 for p-polarised light and δ=0 for s-polarised light) into the p-polarised electric field component which translates into amplitude reflection coefficients. The leaky TEᵥ/TMᵥ mode propagation constants were calculated using the dispersion relationships derived in “Optical Fibre Waveguide Analysis”; C. Tsao, Oxford University Press, ISBN-10: 01 98563442, and a conformal mapping technique, and are given by solving the following two expressions for the propagation constant for the TMᵥ modes [equation 4a], and TEv modes [equation 4b].

$$\begin{matrix}( \begin{matrix}\frac{{J}_{v}^{′} ( {u}_{1} {r}_{1} )}{{u}_{1} r \cdot {J}_{v} ( {u}_{1} {r}_{1} )} \cdot \\ {P}_{v} + {s}_{21} \cdot \frac{{Q}_{v}}{{W}_{2}}\end{matrix} ) \cdot ( \begin{matrix}\frac{{K}_{v}^{′} ( {w}_{3} {r}_{2} )}{{w}_{3} {r}_{2} \cdot {K}_{v} ( {w}_{3} {r}_{2} )} - \\ {s}_{23} \frac{{R}_{v}}{{α}_{2} \cdot {W}_{2}}\end{matrix} ) = {( \frac{{n}_{2}^{2}}{{n}_{1} {n}_{3} {α}_{2} {W}_{2}^{2}} )}^{2} & ( 4 a ) \\ ( \begin{matrix}\frac{{J}_{v}^{′} ( {u}_{1} {r}_{1} )}{{u}_{1} r \cdot {J}_{v} ( {u}_{1} {r}_{1} )} \cdot \\ {P}_{v} + \frac{{Q}_{v}}{{W}_{2}}\end{matrix} ) \cdot ( \begin{matrix}\frac{{K}_{v}^{′} ( {w}_{3} {r}_{2} )}{{w}_{3} {r}_{2} \cdot {K}_{v} ( {w}_{3} {r}_{2} )} - \\ \frac{{R}_{v}}{{α}_{2} \cdot {W}_{2}}\end{matrix} ) = {( \frac{1}{{α}_{2} {W}_{2}^{2}} )}^{2} & ( 4 b )\end{matrix}$$

where phase parameters

$${u}_{1}^{2} = ( {k}^{2} {n}_{1}^{2} - {β}^{2} ) ( 1 - {x}_{1} / {r}_{2} ) , \\ {w}_{2}^{2} = ( {β}^{2} - {k}^{2} {n}_{2}^{2} ) ( 1 - {x}_{1} / {r}_{2} ) = {W}_{2}^{2} / {r}_{1}^{2}$$

$$and$$

$${w}_{3}^{2} = ( {β}^{2} - {k}^{2} {n}_{3}^{2} ) ( 1 - {x}_{1} / {r}_{2} ) = {W}_{3}^{2} / {r}_{2}^{2}$$

$$and$$

$${s}_{21} = \frac{{n}_{2}^{2}}{{n}_{1}^{2}}$$

$$and$$

$${s}_{23} = \sqrt{\frac{{n}_{2}^{2}}{{n}_{3}^{2}}}$$

$$and$$

$${α}_{2} = \frac{{r}_{2}}{{r}_{1}} = \frac{{R}_{1} + d + \sqrt{( 2 {R}_{1} d + {d}^{2} )}}{{R}_{1}}$$

and where the Bessel cross products are

Pᵥ=Iᵥ(w₂r₂)Kᵥ(w₂r₁)−Iᵥ(w₂r₁)Kᵥ(w₂r₂)

and

Qᵥ=Iᵥ(w₂r₂)Kᵥ′(w₂r₁)−Iᵥ′(w₂r₁)Kᵥ(w₂r₂)

and

Rᵥ=Iᵥ′(w₂r₂)Kᵥ(w₂r₁)−Iᵥ(w₂r₁)Kᵥ′(w₂r₂)

where k is the wave number, n₁ is the refractive index of the core, n₂ is the cladding index, and n₃ is the index of the metal (Silver). The parameters r₁ and r₂ are radii of the two concentric circles on an alternative ζ-plane after the Mobius transform z=r₂(z−x₁)/(z−x₂) with

x₁=R₁+d−\sqrt{(2R₁d+d²)}, x₂=R₁+d+\sqrt{(2R₁d+d₂)}=r₂

and r₁=R₁, where d is the separation between the core-cladding interface and the metal surface and R₁ is the core radius (see: H. Raether: “Surface Plasmons on smooth and Rough Surfaces and on Gratings”; Springer Verlag, ISBN 3-540-17363-3 for details of the technique).

The method adopted to solve expressions (4a) and (4b) above, is a zoom search approach, in which the l.h.s. of expression (1) was evaluated for ranges of real β, and values of β are chosen such that l.h.s. of expression (4a) or (4b) are minimised or zero. Following this stage, it is repeated for a range of imaginary β values for a given real β solution. This approach yields the leaky TMᵥ cladding modes of the D-shaped fibre with a coated flat.

The second stage is to calculate the coupling constants for the core mode to cladding modes for a tilted Bragg grating in such an optical fibre. Firstly, use is made of the Debye potential functions, derived from the Helmholtz wave equation, to formulate the field components of the TEv/TMᵥ modes using the calculated β from expressions (4a) and (4b). The boundary continuity conditions and the normalisation procedure are used to obtain expressions for the constants introduced for continuity, yielding expressions (5) to (7) giving the non-zero components of the TMᵥ cladding modes:

$$\begin{matrix}{E}_{r}^{cl} = \frac{β \cdot {u}_{1} {A}_{1} {Ψ}_{1}}{ω \cdot {w}_{2} {ɛ}_{1} {Ψ}_{2}} \cdot [ {I}_{v}^{′} ( {w}_{2} r ) - ( \begin{matrix}\begin{matrix}\frac{{Ψ}_{2} {ɛ}_{1} {w}_{2}}{{Ψ}_{1} {ɛ}_{2}} \cdot \\ {J}_{v}^{′} ( {u}_{1} {r}_{1} ) +\end{matrix} \\ {I}_{v}^{′} ( {w}_{2} {r}_{1} )\end{matrix} ) \frac{{K}_{v}^{′} ( {w}_{2} r )}{{K}_{v}^{′} ( {w}_{2} {r}_{1} )} ] \\ and & ( 5 ) \\ {H}_{φ}^{cl} = \frac{{u}_{1} {A}_{1} {ɛ}_{2} {Ψ}_{1}}{{w}_{2}^{2} {ɛ}_{1} {Ψ}_{2}} \cdot [ {I}_{v}^{′} ( {w}_{2} r ) - ( \begin{matrix}\begin{matrix}\frac{{Ψ}_{2} {ɛ}_{1} {w}_{2}}{{Ψ}_{1} {ɛ}_{2}} \cdot \\ {J}_{v}^{′} ( {u}_{1} {r}_{1} ) +\end{matrix} \\ {I}_{v}^{′} ( {w}_{2} {r}_{1} )\end{matrix} ) \frac{{K}_{v}^{′} ( {w}_{2} r )}{{K}_{v}^{′} ( {w}_{2} {r}_{1} )} ] \\ and & ( 6 ) \\ {E}_{z}^{cl} = \frac{{u}_{1} {A}_{1} {Ψ}_{1}}{i {ωɛ}_{1} {Ψ}_{2}} \cdot [ {I}_{v}^{′} ( {w}_{2} r ) - ( \begin{matrix}\begin{matrix}\frac{{Ψ}_{2} {ɛ}_{1} {w}_{2}}{{Ψ}_{1} {ɛ}_{2}} \cdot \\ {J}_{v}^{′} ( {u}_{1} {r}_{1} ) +\end{matrix} \\ {I}_{v}^{′} ( {w}_{2} {r}_{1} )\end{matrix} ) \frac{{K}_{v}^{′} ( {w}_{2} r )}{{K}_{v}^{′} ( {w}_{2} {r}_{1} )} ] \\ with \\ {Ψ}_{1} = {u}_{1} {J}_{v} ( {u}_{1} {r}_{1} ) {K}_{v}^{′} ( {w}_{2} {r}_{1} ) - {w}_{2} {J}_{v}^{′} ( {u}_{1} {r}_{1} ) {K}_{v}^{′} ( {w}_{2} {r}_{1} ) \\ and \\ {Ψ}_{2} = {K}_{v} ( {w}_{2} {r}_{1} ) {I}_{v}^{′} ( {w}_{2} {r}_{1} ) - {K}_{v}^{′} ( {w}_{2} {r}_{1} ) {I}_{v} ( {w}_{2} {r}_{1} ) & ( 7 )\end{matrix}$$

where Jᵥ(u₁r₁) is a Bessel function of the first kind of order and Jᵥ′(u₁r₁) is the derivative with respect to its argument. The Kᵥ(w₂r₁) and Iᵥ(w₂r₁) are modified Bessel functions of the first and second kind respectively, the dash indicating the first derivative with respect to the argument of these functions. A₁ is the field normalisation constant along with ε₁,ε₂ being the permittivity of the core and cladding respectively.

Calculation of the individual coupling constants for each cladding mode from the core mode, was made to confirm which leaky cladding modes are effectively being coupled too by the TFBG. This is used as a selection process thereby to include only the modes associated with the highest (or a range thereof) coupling coefficients. This is achieved by evaluating the coupling coefficients with the following expression

$${k}_{cl - co} = {\int }_{0}^{2 π} {\int }_{0}^{{r}_{1}} {E}_{co} \cdot {\overline{E}}_{cl} exp ( i {K}_{t} sin ( φ ) ) r d r d φ \qquad ( 8 )$$

in which Ē_{cl} is the conjugate of the cladding mode electric field which is derived using the methods described in “Optical Fibre Waveguide Analysis”; C. Tsao, Oxford University Press, ISBN-10: 0198563442 and in “Fibre Mode Coupling in Transmissive and Reflective Tilted Fibre Gratings”; K S Lee et al., Applied Optics, Vol. 39, No. 9, pp1394-1404, and using expressions (5) to (7) to describe the components of the cladding mode electric field. The core mode is expressed as the LP₀₁ mode field in the fibre core with polarisation dependency given by

$${E}_{co} = {J}_{0} ( {u}_{1} {r}_{1} ) cos ( φ - δ ) \cdot \hat{r} - {J}_{0} ( {u}_{1} {r}_{1} ) sin ( φ - δ ) \cdot \hat{φ} + \frac{{iu}_{1}}{{β}_{co}} {J}_{1} ( {u}_{1} {r}_{1} ) cos ( φ - δ ) \cdot \hat{z} \qquad ( 9 )$$

where β_{c0} is the fundamental core mode propagation constant, and δ is the polarisation angle with respect to the x axis of the fibre which, in the case of the lapped D-shaped fibre, is parallel to the flat of the D. A polarisation angle of δ=0° represents s-polarised light and δ=90° represents p-polarised light, with the cladding mode fields described by expressions (5) to (7). Kₜ is the transverse wave number of the tilted grating which relates to the grating wave vector along the fibre axis Kₜ=−2 sin(θ)/Λ where Λ is the period of the grating and θ is the angle of tilt of the grating. The electric field components are derived from the Helmholtz wave equation and the subscripts r, φ and z refer to the cylindrical polar coordinate system.

The theoretical analysis shows that a TFBG couples to higher order TM_{η,v} modes in a D-shaped fibre as compared to a multimode or a single mode circular cross-section fibre, thus producing a larger range of scattering angles. For values of η higher than η=2 the coupling coefficients became significantly less then for the lower order TM modes and that for values of v exceeding 13 the values for coupling coefficients dramatically decreased, typical values calculated are shown in FIG. 18 which show the coupling coefficient for TM₀ modes for a device of FIG. 5 containing a tilted grating 7° degree with a silver coated D-shaped fibre.

Using these TM leaky modes it is possible to produce a strong SPR coupling in a simulated transmission spectrum of a device of the type shown in FIG. 5, within a surrounding medium having a refractive index of 1.36. This coupling may be observed by altering the simulated polarisation (angle δ) of the illuminating light. The angle δ is the polarisation angle with respect to the x axis of the simulated fibre (in the case of the D-shaped fibre; parallel to the flat of the D represents s-polarised light, and normal to the flat of the D represents p-polarised light). The predicted transmission spectra of this SPR fibre device is shown in FIG. 19 along with the spectral response and the coupling strength shown in FIG. 20.

FIG. 19 shows predicted transmission spectra of a simulated SPR fibre device with changing the P-polarisation of the illuminating light (tilted grating 7° degree in a D-shaped fibre with a silver coated flat, coating thickness 36 nm) with a surrounding medium of 1.36. Seven spectra are shown for seven respective polarisation angles from 2 degrees to 8 degrees, in steps of one degree, and in order of increasing angle as indicated by the horizontal arrow.

FIG. 20 shows the simulated spectral response (FIG. 20(a)) and coupling strength (FIG. 20(b)) of a SPR fibre device as a function of the change in the p-polarisation state (angle) of the illuminating light (tilted grating 30 degree in a D-shaped with a silver coated flat thickness 36 nm) with a surrounding medium of 1.36.

It is noted that, for a given simulated polarisation state of illuminating light, few simulated TM modes contributed to the main spectral feature with respect to the simulated spectra of the SPR fibre device, for a given surrounding index. In the case of indices of 1.36, these modes were TM₀(0,1), TM₁(2,3) and TM₂(1,2,3), with a net effect of broadening of the SPR coupling feature.

Comparing the simulated spectra to experimental data in the figures, one can see that the observed (experimental) spectral broadening appears to exceed theoretical predictions; the observed FWHM is ˜350 nm compared FWHM of ˜100 nm from theory. Including higher order TM modes in the calculation for the predicted transmission spectra did not significantly increase the broadening of the spectral feature. The experimentally observed width of the SPR is much larger than that expected from intrinsic losses alone and this points to a conclusion that propagation lengths of the surface plasmons are much shorter than expected. These results suggest that there is a high degree of surface roughness or non-uniformities of the silver film that has been sputtered onto the lapped flat region of the SPR fibre device.

The surface roughness of the silver coating was measured by an Atomic Force Microscope (AFM). FIG. 21 shows an image of the surface roughness of the Sliver coating formed on a D-shaped fibre taken with AFM. Measurement was made using NanoRule+“Pacific Nanotechnology Software”, with the data obtained via the AFM.

FIG. 22 shows an analysis of the Silver coating on the D-shaped fibre: FIG. 22(a) showing a scatter plot of grain height against grain length; FIG. 22(b) showing a scatter plot of grain width against grains length. The measured silver coatings typically had a medium step height of ˜23 nm with a measured roughness average of ˜6 nm ranging up to ˜58 nm. This may have an effect on the SPR generated in the wavelength range of 1000 nm to 1700 nm due to the fact that “skin depth” of Silver at wavelengths in that spectral range is ˜10 nm. Also the granularity dimensions of the silver varied in length from ˜1.8 μm to ˜0.1 μm with an average granularity of ˜0.8 μm. The width of the grains varied from ˜1.1 μm to ˜0.1 μm with an average grain width of ˜0.5 μm. These dimensions are similar to propagation lengths of surface plasmons generated by the fibre device, which indicates that these devices are producing localised plasmons. Also these propagation lengths are of similar dimensions to the granularity of the silver surface observed by AFM, further indicating that these devices are producing highly localised plasmons.

FIG. 23 shows the measured spectral location (dashed lines) and coupling strengths (SPR depth; see solid lines) of transmission spectra carried out over a range of different polarisation angles for each of three different respective index values of the medium surrounding the sensor.

Comparing FIGS. 23 and 20, and the spectral tune ability and coupling strength of the SPR as a function of polarisation, one can see that the experimental data (FIG. 23) shows a higher sensitivity to polarisation state of the illuminating light than the theoretical data (FIG. 20). This may be due to the fact that the lapped fibre may not be quite a D-shaped but has more asymmetric geometric features which cause greater polarisation dependence. The predicted coupling strength is much higher than was experimentally observed. This may be expected because roughness was not included in the model of the SPR device.

Furthermore, calculations to reproduce the transmission spectra of the SPR devices suggest that for different polarisation states, surface plasmons are being generated from the same spatial regions with different resonant wavelengths. This points to a conclusion that the spatial extension of the evanescent fields of the SP at a given spatial location is controlled via the polarisation of the illuminating light.

The simulation/theory was also used to predict the spectral behaviour of the SPR fibre device as a function of the surrounding mediums refractive index. FIG. 24 and FIG. 25 shows an example of the theoretically predicted transmission as a function of index (FIG. 25) and the corresponding spectral response (FIG. 25(a)) and coupling strength (FIG. 25(b)) is shown in FIG. 25.

In particular, FIG. 24 shows the predicted response of the transmission spectrum of the device, for a given polarisation state of illuminating radiation, as a function of the surrounding medium's refractive index for a SPR fibre device with a TFBG having a tilt angle of 7 degrees.

The predicted spectral response shown in FIG. 25(a) and the predicted coupling strength shown in FIG. 25(b) of a SPR fibre device, is shown as a function of the surrounding medium's refractive index for a given P-polarisation state of the illuminating light (tilted grating 70 degree in a D-shaped with a silver coated flat thickness 36 nm).

Comparing theoretically predicted behaviour with the experimentally observed data shows some differences but the same general trends. The simulation represents the idealised case assuming purely p-polarised light and no surface roughness of the silver coating of the SPR fibre device. This can explain the differences in terms of strength of coupling and the spectral response of the SPR with regards to the spectral location of the coupling. The modelling suggests that under optimum fabrication and working conditions for a tilted grating of 70 degrees SPR device an index spectral sensitivity of Δλ/Δn ˜18000 nm is achievable leading to a resolution (under the assumption of a 0.1 nm measurement resolution for the resonance wavelength) of ˜5×10⁻⁶ over the index range of 1.34 to 1.37.

Inspecting the results of the simulation shows the bandwidths for indices of 1.35 and above to be considerably narrower than the experimental results shown; ˜100 nm compared to ˜400 nm. The width of the observed resonances suggests that these SPs have short propagation lengths, which may be exploited for some applications (SPR imaging techniques).

To this end the propagation constants of the SP along the metal/dielectric interface were calculated from the experimental data, thus giving some indication of the spatial localisation of the SPs. The intrinsic loss (Γᵢ) of the fibre SPR device is based upon the optical properties of the materials used, and can be approximated using

$${Γ}_{i} = \frac{{n}_{s}^{3} {k}_{0} {ɛ}_{i}}{2 {ɛ}_{r}^{2}} \qquad ( 10 )$$

where nₛ is the refractive index of the test sample, k₀ is the free space propagation constant, εᵢ and εᵣ are the imaginary and real permittivities of the metal film. The radiative loss term (Γᵣ which can be interpreted as an additional loss generated from light being reradiated into the cladding caused by surface roughness) can used to obtain the propagation constant of the SP. This loss term was estimated from experimental results, such as those shown in FIGS. 7 and 16, as

$${W}_{k} = \frac{2 ( {Γ}_{i} + {Γ}_{r} )}{2 {n}_{2} {k}_{0} cos ( ϕ )} \qquad ( 11 )$$

where Wₖ is the observed width of the SPR at half maximum (see FIGS. 7 and 16), n₂ is the index of the cladding and φ is the angle of incidence on the metal coating of radiation emitted from the TFBG. The term Γᵢ is determined via expression (10) above. The angle φ was calculated using the scattering angles associated with the various TM propagation constants (n_{β}) generated by a D-shaped fibre (with a silver coating), using the relationship given by the ray approach; sin(φ)=n_{β}/n₂. The angle φ was used to determine the projection of the incident wave-number along the metal/dielectric interface. Surface plasmons are generated when this wave-number projection matches the dispersion relation of the plasmons given by expression (1) above. The TFBG enhances coupling to higher order TM modes to produce a larger range of scattering angles than in multimode or circular cladding single mode fibre.

The radiative loss term (Γᵣ) is a quantity obtained from expression (11) above and can be used to obtain the propagation length (Lₓ) of the SP (which yields an estimate of spatial resolution) via the characteristic propagation constant, and which is defined for a non-smooth surface as:

$${L}_{x} = \frac{1}{2 ( Im \{ {k}_{0} \sqrt{\frac{{ɛ}_{m} \cdot {n}_{s}^{2}}{{ɛ}_{m} + {n}_{s}^{2}}} + {Γ}_{r} \} )} \qquad ( 12 )$$

The experimentally observed width of the resonance (Wₖ) is much larger than that expected from the intrinsic loss alone. This suggests that the Plasmon propagation lengths along the metal/dielectric interface are short, ranging from about 40 nm to 120 nm, or up to 140 nm, see FIG. 26. This may be contrasted with typical values from smooth surfaces which range from 50 μm to 150 μm and which have associated with them an SPR spectral width at half maximum of just a few nanometres. FIG. 26 shows the characteristic propagation length of the SPs as a function of wavelength if illuminating radiation calculated using expressions (10), (11) and (12) above and empirically determined data.

These propagation lengths are of similar dimensions to the granularity of the silver surface observed by AFM, which suggests that these devices are producing highly spatially localised surface plasmons. Using an atomic force microscope (AFM) it was found that the silver coating (item 18, FIG. 5) applied to the devices studied had an average thickness of 35 nm with a standard deviation of ˜6 nm, as discussed above with reference to FIGS. 21 and 22.

A SPR generator is provided in the form of a fibre device utilising a tilted fibre Bragg grating to enhance the coupling of the illuminating IR light to localised surface Plasmon resonances on a silver coated lapped single mode fibre. By altering the polarisation dependence of the light surface plasmon resonances can be tuned over the spectral range from 1100 nm to 1700 nm with extinction ratios in excess of 35 dB for the aqueous index regime (1.34 to 1.37). Also the polarisation dependence can control the spatial extension of the surface plasmon at a given spatial location. A theoretical model showed reasonable agreement with the experimental data with regard to polarisation dependence and refractive index, and showed that an index resolution of ˜10⁻⁶ is possible.

Variants of, and alternatives to, the examples of the invention described, such as would be readily apparent to the skilled person, are encompassed within the present invention, and the examples given above with reference to the accompanying drawings, are not intended to be limiting.

1-33. (canceled)

34. A surface plasmon generator comprising an optical waveguide having an input part for receiving optical radiation into the optical waveguide, a refractive index modulation arranged within the optical waveguide, and a layer of metal arranged upon a surface of the optical waveguide to form an interface therewith and to outwardly present a metal surface covering the interface, wherein the refractive index modulation extends to form an area obliquely facing the interface thereby to render the interface in optical communication with the input part, and wherein the refractive index modulation is arranged to reflect a part of input optical radiation at the refractive index modulation to form a radiative optical mode(s) of light for generating a surface plasmon at the outwardly presented metal surface, which radiative optical mode(s) of light is coupled to a guided optical mode(s) of light in the optical waveguide such that a change in the radiative mode(s) of light causes a change in the guided optical mode(s) of light.

35. The surface plasmon generator according to claim 34, wherein the refractive index modulation defines a substantially planar area obliquely presented to the interface and to the direction from which it is arranged to receive optical radiation from the input part.

36. The surface plasmon generator according to claim 34, wherein the optical waveguide has a core part and cladding part adjacent the core part, and the refractive index modulation extends across at least a part of the core part of the optical waveguide.

37. The surface plasmon generator according to claim 34, further comprising a plurality of said refractive index modulations collectively defining a tilted diffraction grating structure such as a tilted Bragg grating within the optical waveguide extending along the optical transmission axis thereof.

38. The surface plasmon generator according to claim 34, wherein the optical waveguide has a core part and a cladding part adjacent to the core part which is lapped to define a proximal outer surface area being closer to the core part than are other adjacent outer surface areas of the cladding part, wherein the layer of metal is formed upon the proximal outer surface area.

39. The surface plasmon generator according to claim 34, wherein the input part of the optical waveguide is an end of the waveguide and the optical waveguide includes an output part comprising an end of the waveguide for receiving optical radiation having passed through the refractive index modulation(s) from the input part.

40. A sensor comprising:
a surface plasmon generator according to claim 34;
an optical radiation source in optical communication with the input part of the surface plasmon generator; and
an optical radiation detector arranged to detect optical radiation having passed through the refractive index modulation from the input part,
wherein the outwardly presented metal surface defines a sensing area for receiving a sample to be sensed using surface plasmons.

41. The sensor according to claim 40, further comprising a polarisation control means in optical communication with the optical radiation source and the input part of the surface plasmon generator, the polarisation control means being arranged for controlling the state of polarisation of optical radiation from the optical radiation source for input to the surface plasmon generator.

42. The sensor according to claim 40, wherein the optical radiation source is arranged to generate broadband optical radiation comprising a range of optical wavelengths.

43. A sample analyser for analysing a sample of a substance using surface plasmon resonances, the sample analyser comprising a sensor according to claim 40, and a signal processor means arranged to identify resonances in the spectrum of optical radiation received in the analyser from the optical radiation source via the surface plasmon generator.

44. The sample analyser according to claim 43, wherein the signal processor means is arranged to determine one or more of: the position; the depth; the width of an identified resonance.

45. A method for generating a surface plasmon comprising:
providing a surface plasmon generator according to claim 34;
directing optical radiation into the surface plasmon generator via the input part thereof;
reflecting a part of the input optical radiation at the refractive index modulation(s) towards the interface to form a radiative optical mode(s) of light which is coupled to guided optical mode(s) of light in the optical waveguide such that a change in the radiative mode(s) of light causes a change in the guided optical mode(s) of light; and
generating a surface plasmon at the outwardly presented metal surface using the radiative optical mode(s) of the reflected part of the input optical radiation.

46. A method of sensing a sample substance, the method comprising:
generating a surface plasmon according to the method of claim 45 when the sample substance is placed in contact with the outwardly presented metal surface of the plasmon generator;
transmitting a part of the input optical radiation through the refractive index modulation(s);and
detecting the intensity of the transmitted part of the input optical radiation thereby to sense the sample substance using the surface plasmon.

47. The method of sensing according to claim 46, further comprising detecting a minimum in the radiation intensity in the optical spectrum of the transmitted part of the input optical radiation.

48. The method of sample analysis comprising:
performing the method of sensing a sample substance according to claim 46; and
measuring changes in a property of the transmitted part of the input optical radiation in dependence upon changes in a property of the sample being sensed.
